(19) United States
(12) Patent Application Publication
(10) Pub. No.: US 2013/0085467 A1
(43) Pub. Date: Apr. 4, 2013

(54) ROBOTIC INFUSION MIXER AND TRANSPORTABLE CARTRIDGE

(71) Applicant: BOARD OF REGENTS, THE UNIVERSITY OF THE TEXAS SYSTEM, Austin, TX (US)

(72) Inventor: Christopher C. CAPELLI, Houston, TX (US)

(73) Assignee: BOARD OF REGENTS, THE UNIVERSITY OF TEXAS SYSTEM, Austin, TX (US)

(21) Appl. No.: 13/627,405

(22) Filed: Sep. 26, 2012

Related U.S. Application Data
(60) Provisional application No. 61/539,502, filed on Sep. 27, 2011.

(51) Int. Cl. A61J 1/14

(52) U.S. Cl. CPC A61J 1/14
USPC 604/416

(57) ABSTRACT

The invention relates to a transportable therapeutic cartridge, a therapeutic agent robotic mixer and a method for providing therapeutic infusion services. The transportable therapeutic cartridge is configured to be used to manually mix therapeutic agents or to be coupled to a therapeutic agent robotic mixer, such that the robotic mixer can access therapeutic agents disposed in the cartridge. The cartridge, mixer, and method provide therapeutic infusions in a just-in-time fashion, so as to minimize risk to patients and facility staff while maximizing the use and safety of the therapeutics.

### CROSS-REFERENCE TO RELATED APPLICATIONS

This application claims priority to U.S. Provisional Patent Application Ser. No. 61/539,502 filed Sep. 27, 2011 and entitled “Robotic Infusion Mixer and Transportable Cartridge”, the entire contents of which are incorporated herein by reference.

### TECHNICAL FIELD

This invention relates to a robotic formulation mixer and cartridge, and to methods of mixing pharmaceutical formulations at remote locations.

### BACKGROUND OF THE INVENTION

In the United States, a Pharmacy Benefit Manager (PBM) is a third party administrator of prescription drug programs. They are primarily responsible for processing and paying prescription drug claims. They also are responsible for developing and maintaining the formulary, contracting with pharmacies, and negotiating discounts and rebates with drug manufacturers. Today, more than 210 million Americans nationwide receive drug benefits administered by PBMs. Fortune 500 employers, and public purchasers (i.e., Medicare Part D, the Federal Employees Health Benefits Program) provide prescription drug benefits to the vast majority of American workers and retirees.

PBMs aggregate the buying clout of millions of enrollees through their client health plans, enabling plan sponsors and individuals to obtain lower prices for their prescription drugs through price discounts from retail pharmacies, rebates from pharmaceutical manufacturers, and the efficiencies of mail-service pharmacies. PBMs also use clinical tools aimed at reducing inappropriate prescribing by physicians, reducing medication errors, and improving consumer compliance and health outcomes.

Currently, in the United States, a majority of the huge managed prescription drug benefit expenditures are conducted by about 60 PBMs. For the most part, PBM's vast majority of the business is the supply of oral medications. One of the key reasons for this is that these type of medications can be supplied from centralized distribution centers through the mail to a physician offices or directly to a patient's home. As a result, PBM's can offer convenient access to prescriptions at discounted prices.

The market for therapeutic infusions is substantial. For example, the U.S. market in 2006 for chemotherapeutic infusion was $42 billion. Due to new infusion therapies being introduced, the market for therapeutic infusions is growing rapidly. In the United States, 80% of the chemotherapeutic infusions are provided at community oncologist facilities or clinics. The current process involves the healthcare provider purchasing a therapeutic agent in a vial or other container from the manufacturer or distributor and storing the therapeutics. At the time a patient is scheduled to receive a specific therapeutic infusion, a technician or pharmacist within the healthcare provider's facility prepares a therapeutic infusion by mixing required chemotherapeutic agents with appropriate diluents. Once prepared, the therapeutic infusions are administered to the patient. Finally, any remaining drug not used is disposed of.

This presents a number of risks and costs for both the patient and the healthcare facility staff associated with mixing and delivering the therapeutic infusions at these facilities. For the healthcare provider, administering therapeutic infusions outside the hospital setting requires mixing of the therapeutic agents with the appropriate diluents at remote locations. These risk and costs include inefficient utilization of the therapeutic agents, increased patient risk, increase technician or pharmacist risk, and administrative and financial risk.

For the patient, there are risks associated with contaminated medication as well as risks associated with medication errors. Once a therapeutic agent's drug vial has been opened, contamination concerns are a major risk for the patient. Furthermore, because sterility cannot be guaranteed over long periods, once a therapeutic agent's drug vial has been open its expiration time is typically limited to 24 hours. As a result, unless the practice has a large number of patients undergoing the same therapy, greater than 13% of the total accumulated costs of the drug can be waste. Thus, a major problem of mixing and providing injectable therapeutic drugs at remote locations is the inefficient utilization of the therapeutic agents The risks associated with medication errors results from incorrect formulation or mixing of the therapeutic infusion by the technician or staff member within the oncologist office facilities. While not a common occurrence in a hospital setting that has a full fledge pharmacy, distant healthcare facilities typically use non-pharmacist technicians to mix infusion formulations. With this lower level of expertise, the chances of medication errors increases dramatically.

In addition to the patient's risk, the technician and/or pharmacist have risk associate with the health hazards from long hours and exposure to anticancer therapeutics. In a study by Nygram, a comparison for a new closed system for the preparation and administration of drugs with the traditional technique with regard to airborne mission and surface pillage of the drugs was undertaken. The results of the study showed that the mean airborne emission was 6 ng/m3 in the close system and 15 ng/m3 the traditional pump technique. Average surface pillage using the close technique was 0.005 μL. This was found to be significantly smaller than the traditional technique, which resulted in an average spillage of 64 μL.

Finally, the need for skilled staff at remote locations that have the expertise and experience to formulate therapeutic infusions adds to the financial cost of administering and oncologist practice. Additional risk and cost include waste management and inventory control for acquiring, holding, and disposing of the therapeutic agents.

PBM's have been seeking approaches to provide benefits management for chemo infusion drugs as well other infusion therapies. Ideally, a PBM could compete with the current approach by providing services including acquiring the therapeutic drugs, mixing the therapeutic drugs into infusions and then shipping said to the physician's office for administration to the patient. By providing these services, the risk and costs associated with acquiring, holding, mixing and administrating therapeutic agents for both the patient and staff can be minimized.

Unfortunately, in the real world, patients who are scheduled to come in for their therapeutic often have to reschedule their appointments because of their current health situation (e.g. the patient may be running a fever, have a cold, etc.). In these cases, given that the PBM has already made the therapeutic infusion and shipped it for administration to the patient, the therapeutic infusion would be wasted. As a result, given the high cost of the therapeutic agents used in these infusions, the risk and cost is too high for the PBM to provide therapeutic infusion benefits management services in a cost-effective way.

Robotic systems that formulate standard infusion medications have been described. For example, U.S. Pat. No. 7,240,699 describes an automated medication preparation system. This invention relates generally to medical and pharmaceutical equipment, and more particularly, to an automated system for preparing a syringe to receive a unit dose of medication; dispensing the unit dose of medication from an injectable drug vial to this range; and features that monitors and determines whether the injectable drug vial is in a proper orientation for one or more stations of the system.

In the preparation of cytostatic drug formulations, US Publication No. 2010/0006602 discusses a robotic formulation mixer comprising a box-type holding frame defining a first chamber, which houses the magazine therein and a second chamber, which houses the dosage station and the gripping and carrier device therein. An aperture is provided in the robotic formulation mixer to allow the operator to load and/or unload the magazine within the first chamber with therapeutic agent containers. The second chamber is maintained in substantially sterile conditions, and is in communication with the first chamber in order to allow the gripping and carrier device to transfer the containers between the magazine and the dosage station. (3)

As pointed out by U.S. Publication No. 2010/0006602, machines described above have had some drawbacks. Mainly, these drawbacks derive from the fact that, when the first chamber is opened to allow the loading and/or unloading operations of the magazine, the first chamber is in communication with the external environment totally exposing the operator to risks correlated to the presence of the cytostatic drugs used in such machines and thus impairing the sterility of prepared pharmaceutical products. In an attempt to overcome the problems of the prior art, the robotic mixer system of U.S. Publication No. 2010/0006602 provides that the first chamber and second chamber is crossed by a sterile air flow adapted to avoid the entry of air into the second chamber from the external environment through aperture of the magazine in the first chamber.

Unfortunately, while the robotic system of above is an improvement, it still has shortcomings. One of the major shortcomings is that the system does not resolve the problems associated with the frequent loading and unloading of the therapeutic agent containers into the system. The loading and/or unloading operations of the magazine still require the machine to be frequently opened to the external environment. As a result, providing a stable sterile environment in the machine is difficult requiring increase complexity in the robot's design and function.

Furthermore, manual filling of the appropriate therapeutic agent containers into the magazine of the robotic mixing system exposes the operator to risks related to the presence of the cytostatic drugs used in such machines. Finally, due to the need to manually fill the robotic system with individual therapeutic agent containers, safety, waste, throughput and reliability are still an issue.

An improved robotic system was provided by U.S. Pat. No. 7,610,115. This invention discloses an Automated Pharmacy Admixture System (APAS) that may include a manipulator that transports medical containers such as bags, vials, or syringes about a substantially aseptic admixing chamber. The Automated Pharmacy Admixture System (APAS) may utilize inventory racks that can be pre-loaded with inventory, which may include vials of various sizes, syringes and/or IV bags. For example, pre-loaded racks of commonly used inputs (e.g., saline IV bags) may be prepared to satisfy anticipated, expected, or planned compounding production orders.

While U.S. Pat. No. 7,610,115 discloses that the racks for the APAS may be prepared in an off-site warehouse where the racks, drug inventory, and container inventory may be stored, the racks themselves are not designed to act as the transport container for the inventory. However, given the design, transporting the racks for the disclosed invention must be done with great care. Any impact shocks associate with transport can cause displacement of the inventory from the racks and result in breakage of the therapeutic containers.

A need exists for a robotic infusion mixer system that delivers therapeutic infusions in a safe, accurate, efficient, sterile, and just-in-time fashion. Furthermore, a need exists for a robotic infusion mixer system that delivers therapeutic infusions where the labor to manually load and unload individual therapeutic agent containers into the robotic mixer system is minimized through the use of a therapeutic cartridge. Still furthermore, a need exists for a robotic infusion mixer system that delivers therapeutic infusions through the use of a therapeutic cartridge wherein the therapeutic can be preloaded off-site and transported to the site of the robotic infusion mixer system without breakage of the therapeutic containers. In this way, transfer of environmental contaminants into the cartridge is reduced and the escape of hazardous drug outside the cartridge is minimized.

Additionally, a method for providing infusion benefits management services in a just-in-time approach to a physician so as to minimize the financial risk associated with patient rescheduling their appointments is needed. Further, what is needed is a method for providing infusion benefits management services in a just-in-time approach to a physician that decreases the medical risk to both the patient and physician's staff. Still further, what is needed is a method for providing infusion benefits management services to a physician in a just-in-time approach that minimizes the costs to the physician associated with acquiring, holding, mixing and administrating therapeutic agents and the medical risks to both the patient and its staff.

### BRIEF SUMMARY OF THE INVENTION

The present invention is directed to an apparatus and system for a formulation mixer and pharmaceutical cartridge, and methods of mixing pharmaceutical formulations at a remote location.

An embodiment of the invention is for a robotic infusion mixer system for remote, just-in-time formulation of therapeutic infusions comprising a remote robotic infusion mixer and one or more transportable therapeutic cartridges wherein the therapeutic cartridge loaded with therapeutic containers can be inserted directly into the robotic infusion mixer to provide robotic mixer with therapeutic agent for the production of therapeutic infusions.

An embodiment of the robotic infusion mixer consists of at least a therapeutic cartridge handling mechanism; a dosage station for the preparation of a pharmaceutical product obtained by mixing at least one chemotherapeutic agents and at least one diluent; and a gripping and/or carrier device to transfer the therapeutic agent container between the therapeutic cartridge and the dosage station.

In one embodiment of this invention, the transportable therapeutic cartridge comprises at least a transport shell and a receptacle structure. The transport shell may provide a closed-system environment for therapeutic agent containers. The receptacle structures are defined by one compartment or a plurality of compartments for holding therapeutic agent containers that are designed cartridge to be used to manually mix therapeutic agents or to be directly inserted into the robotic mixer as well as protect the contents from forces or impact shocks associate with transport, thus preventing breakage of the therapeutic containers. The therapeutic cartridge's receptacle structure can be preloaded external to the robotic infusions formulation mixer with different therapeutic agent containers and enclosed in the transport shell for transportation and placement into the robot infusion mixer. The therapeutic cartridge provides a closed system for the transport of the therapeutic agent containers from throughout the process and provides an improved stable environment for the therapeutic agents and the robotic infusion mixer. That is to say, the transportable cartridge mechanically prohibits the transfer of environmental contaminants into the cartridge and the escape of hazardous drug outside the cartridge. The transportable therapeutic cartridges can be replaced on a periodic basis so as to replenish the robotic infusion mixer.

In another embodiment, the robotic infusion mixer can receive and store formulation instructions to prepare a therapeutic infusion using the therapeutic agents in preloaded therapeutic cartridges. These therapeutic infusions can be prepared at the time proximal to administering the therapeutic infusion to the patient.

Embodiments of the robotic infusion formulation mixer system can improve patient and provider safety while reducing waste and costs. Specifically, the use of a transportable therapeutic cartridge in conjunction with the robotic system maximizes patient safety by reducing medication errors while improving operator safety by minimizing exposure to toxic therapeutic agents. More importantly, the use of preloaded therapeutic cartridges permits the robotic formulation mixer to have a stable internal environment during transportation and when placed into the robotic mixer. Finally, the use of the robotic system of this invention minimizes administrative costs and maximizes healthcare efficiency by decreasing drug waste, improving inventory control and improving personnel utilization.

An embodiment of the invention is a method for providing therapeutic infusion benefits management services to a healthcare provider at a distant healthcare facility. The method consists of the service provider acquiring and holding therapeutic agents; selectively loading one or more of said therapeutic agent vials into a cartridge; and transporting said cartridge to a distant healthcare facility. The cartridge loaded with the therapeutic agent vial or vials is used in conjunction with a robotic infusion mixer to remotely make therapeutic infusions at said distant healthcare facility for administration to the patient.

In one embodiment, the benefits management service acquires and holds chemotherapeutic agents in vials from a manufacturer or supplier. One or more of said chemotherapeutic agent vials are loaded into a therapeutic cartridge and transported to the distant healthcare facility. On a periodic basis, the one or more preloaded therapeutic cartridge is inserted into the robotic infusion formulation mixer. When needed for the treatment of a patient, a therapeutic infusion is produced utilizing said robotic infusion formulation mixer at the time proximal to administering the chemotherapeutic therapeutic infusion to the patient. This method provides therapeutic infusion benefits management services to a physician in a just-in-time approach that minimizes the physician financial risks associated with acquiring, holding, mixing and administrating therapeutic agents to the patients. Furthermore, this method minimizes the medical risks to both the patient and its staff from manually mixing the therapeutic infusions on site.

An embodiment of the invention provides a method of providing remote just-in-time formulation of therapeutic infusions for a patient comprising the steps of: preloading the transportable therapeutic cartridge external to the robotic infusion mixer system; transporting said therapeutic cartridge to the location having the robotic infusion mixer system; inserting said therapeutic cartridge into the robotic infusion mixer system; producing the therapeutic infusion for the patient; and the therapeutic infusion is administered to the patient by the healthcare provider; wherein the therapeutic infusion is produced using the robotic infusion mixer system; wherein the transportable therapeutic cartridge loaded with therapeutic containers can be inserted directly into the robotic infusion mixer to provide said robotic infusion mixer with therapeutic agent for the production of therapeutic infusions; and wherein the transportable therapeutic cartridge comprises at least a transport shell and a receptacle structure wherein the transport shell provides a closed-system environment for therapeutic agent containers and the receptacle structure provides a structure defining one compartment or a plurality of compartments for holding therapeutic agent containers and said transportable therapeutic cartridge is designed to be directly inserted into the robotic mixer as well as protect the contents from forces or impact shocks associate with transport, thus preventing breakage of the therapeutic containers and mechanically prohibits the transfer of environmental contaminants to the cartridge and the escape of hazardous drug outside the cartridge.

An embodiment of the invention is a transportable therapeutic cartridge comprising a transport shell and a receptacle structure configured to receive one or more therapeutic agents, and to be coupled to the transport shell such that one or more therapeutic agents disposed in the receptacle structure are protected, wherein the cartridge can be used to manually mix therapeutic agents or can be configured to be coupled to a therapeutic agent robotic mixer such that the robotic mixer can access therapeutic agents disposed in the cartridge. The receptacle structure may comprise a plurality of compartments configured to receive therapeutic agent containers and at least one of the plurality of compartments may be a different size or shape that at least one other of the plurality of compartments. Additionally, the plurality of compartments may include one or more resiliently deflectable structure adapted to hold therapeutic agent containers in place. The compartments may further comprise therapeutic agent containers that are configured to be received in the compartments of the receptacle structure, and the therapeutic agent containers may contain one or more chemotherapy drugs. One or more of the plurality of compartments may comprise a recess adjacent the top of the compartment and/or one or more robotic transfer device configured to fit into the recess. The interior of a therapeutic cartridge may contain a particle-free gas. The therapeutic cartridge may be comprised of transparent plastic, such as acrylic. In some embodiments of the invention, the therapeutic cartridge comprises a mechanical interface configured to provide a seal between a robot mixer and the transport shell. The receptacle structure and/or the transport shell may be comprised of polyvinylchloride, polyurethane, and/or thermoplastic rubber.

The cartridge may be configured to resist damage to contents of the cartridge during transport. In some embodiments of the invention, the cartridge is a closed-system drug-transfer device. The transport shell may surround the receptacle structure and may be configured to seal the receptacle within the transport shell, or the transport shell may be configured to be coupled to the receptacle in a cap configuration. In an embodiment of the invention, the transport shell is configured to be coupled to the receptacle to provide a seal between the transport shell and the receptacle. The seal may be airtight and the interior of the cartridge may be sterile. The cartridge may further comprise a means to modulate the pressure of the therapeutic drug container during processing. Still further, the cartridge may comprise a temperature regulator, such as a gel pack, a refrigeration device, water, and/or thermal insulation such as removable multiple insulated liners formed from a plurality of rigid foam panels, and a removable spill containment device, such as a liner, which prevents leakage of liquids and provides additional protective padding.

Another embodiment of the invention is an apparatus comprising a therapeutic agent robotic mixer configured to be coupled to a transportable therapeutic cartridge comprising: a transport shell; and a receptacle structure configured to receive one or more therapeutic agents, and to be coupled to the transport shell such that one or more therapeutic agents disposed in the receptacle structure are protected; wherein the robotic mixer is configured to be coupled to the cartridge such that the robotic mixer can access therapeutic agents disposed in the cartridge.

Another embodiment of the invention is a therapeutic agent robotic mixer comprising: a therapeutic cartridge handling mechanism; a dosage station; a carrier device configured to transfer a therapeutic agent container between the therapeutic cartridge handling mechanism and the dosage station; wherein the therapeutic cartridge handling mechanism is configured to permit the dosage station to access a therapeutic agent container without affecting sterility of the therapeutic agent container. The therapeutic cartridge handling mechanism may additionally comprise a UV sterilizer, or other sterilization apparatus that uses sterilization techniques such as sterilization with aqueous detergent, bacterial solution wash, and/or alcohol solution wash. The therapeutic cartridge handling mechanism may be configured to remove a transport shell from a therapeutic cartridge. The robotic mixer may further comprise a computer, a refrigeration device, an input configured to receive information about loaded therapeutic agents such as a barcode reader or an RFID scanner.

Another embodiment of the invention is a system for formulation of therapeutic infusions comprising: a transportable therapeutic cartridge as described above; a robotic mixer as described above; and a computer remote from and configured to communicate with the robotic mixer, wherein the computer comprises a database, a processor, and a memory to store processor-executable program code. The database may be configured to store information about patients, therapeutic treatments, and therapeutic agents. In an embodiment of the invention, the computer is configured to receive requests for therapeutic agents, is configured to monitor therapeutic agents, is configured to audit therapeutic agents at the location of the computer and at the robotic mixer, and/or is configured to receive information on a treatment protocol for a patient for delivery at the location of the robotic mixer. The computer may also be configured to: determine one or more therapeutic agents needed at the robotic mixer to deliver the treatment protocol; determine whether the robotic mixer has access to the needed therapeutic agents; and sends a request for any therapeutic agents not accessible by the robotic mixer to be sent in a transportable therapeutic cartridge to the location of the robotic mixer. In embodiments of the invention the robotic mixer is configured to receive from the computer information for mixing a therapeutic formulation, to mix the therapeutic formulation based on the received information, and/or to send to the computer information about therapeutic agents to which the robotic mixer has access.

Another embodiment of the invention is a method for providing therapeutic infusion services comprising: sending a transportable therapeutic cartridge having a sealed, sterile interior in which one or more therapeutic agents are disposed; wherein the cartridge is configured to be coupled to a robotic mixer before unsealing the interior such that the robotic mixer can access the one or more therapeutic agents.

An embodiment of the invention is a method for providing therapeutic infusion services comprising: acquiring therapeutic agents; loading one or more of the therapeutic agents into a transportable therapeutic cartridge; sterilizing the therapeutic cartridge; sealing the therapeutic cartridge. The method may further comprise transporting the sealed therapeutic agent to a healthcare location, such as a hospital. In an embodiment of the invention, the transportable therapeutic cartridge is a closed system drug-transfer device. The method may further comprise coupling the therapeutic cartridge to a robotic mixer without breaking the seal of the therapeutic cartridge. The robotic mixer may be configured to break the seal of the therapeutic cartridge after the cartridge is coupled to the robotic mixer. Further, the method may comprise having the robotic mixer mix at least one of the one or more therapeutic agents into a therapeutic formulation for administration to a patient. In an embodiment of the invention, the patient is administered the therapeutic formulation.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a graphical representation of the use of the robotic formulation mixer and components of the robotic infusion formulation mixer system.

FIG. 2 illustrates the stability of the internal environment of a robotic formulation mixer.

FIG. 3 illustrates various embodiments of the therapeutic cartridge and the robotic formulation mixer. FIG. 3a is an illustration of an embodiment of transportable therapeutic cartridge having a transport shell in a cap configuration and a receptacle structure. FIG. 3b is an illustration of one approach to the placement of the therapeutic cartridge into the robotic formulation mixer. FIG. 3c is an illustration of one approach to the transfer of the therapeutic containers from the therapeutic cartridge into the robotic formulation mixer. FIG. 3d is an illustration of another embodiment of transportable therapeutic cartridge having a transport shell that encloses a receptacle structure. FIG. 3e is an illustration of another approach to the approach toward the placement of the therapeutic cartridge into the robotic formulation mixer. FIG. 3f is an illustration of another approach to the approach to the transfer of the therapeutic containers from the therapeutic cartridge into the robotic formulation mixer.

FIG. 4 is an illustration of another embodiment of the receptacle structure of a transportable therapeutic cartridge where the receptacle structure has compartments that contain a pliable structure to hold therapeutic agent containers of different sizes.

FIG. 5 is an illustration of another embodiment of robot assist device for the transportable therapeutic agent canisters.

FIG. 6 is an illustration of another embodiment of the receptacle structure of a transportable therapeutic cartridge where the receptacle structure has compartments that are designed to hold therapeutic agent canisters incorporating a robot assist device.

FIG. 7 is an illustration of yet another embodiment of the transportable therapeutic cartridge comprising a transport shell and a receptacle structure wherein the receptacle structure has a connecting structure which is able to hold one or more therapeutic drug containers that is integral with the transport shell. FIG. 7a provides an illustration of a transportable therapeutic cartridge which is holding one therapeutic drug container. FIG. 7b provides a schematic drawing of the transportable therapeutic cartridge embodiment illustrated in FIG. 7a. FIG. 7c provides a schematic drawing of the receptacle structure embodiment illustrated in FIG. 7b wherein a therapeutic drug cartridge is held by the connecting structure. FIG. 7d provides an illustration of one approach to the loading the transport cartridge 305 as illustrated in FIG. 7a. FIG. 7e provides an illustration of a transportable therapeutic cartridge which is holding two therapeutic drug containers. FIG. 7f provides an illustration of an embodiment with a connecting structure in the form of a needleless injection port.

FIG. 8 is a graphical representation of the process of using the robotic infusion formulation mixer system.

FIG. 9 illustrates a method of providing therapeutic infusion benefits services to a distant healthcare facility

### DETAILED DESCRIPTION OF THE INVENTION

In keeping with long-standing patent law convention, the words “a” and “an” when used in the present specification in concert with the word comprising, including the claims, denote “one or more.” Some embodiments of the invention may consist of or consist essentially of one or more elements, method steps, and/or methods of the invention. It is contemplated that any method or composition described herein can be implemented with respect to any other method or composition described herein.

As used herein “closed-system drug-transfer device” refers to a drug transfer device that mechanically prohibits the transfer of environmental contaminants into a system and the escape of hazardous drug or vapor concentrations outside the system.

Robotic Infusion Mixer System

An embodiment of the invention provides a robotic infusion formulation mixer system for remote just-in-time formulation of therapeutic infusions comprising a remote robotic infusion mixer and one or more transportable therapeutic cartridges. The transportable therapeutic cartridge loaded with therapeutic containers can be inserted directly into the robotic infusion mixer to provide robotic mixer with therapeutic agent for the production of therapeutic infusions.

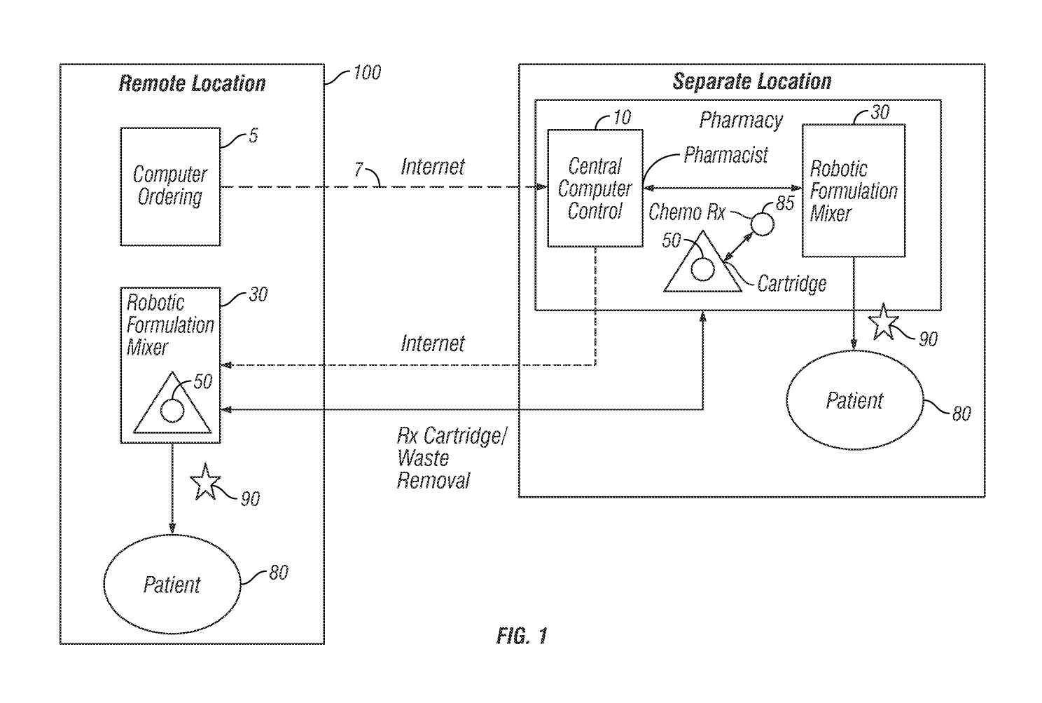

FIG. 1 provides a graphical representation of one embodiment of the robotic infusion formulation mixer system 100 that provides a remote just-in-time formulation of therapeutic infusions 90. The system comprises a remote robotic infusion formulation mixer 30; and one or more therapeutic cartridges 50.

The robotic formulation mixer 30 may consist of a therapeutic cartridge handling mechanism; a dosage station for the preparation of a pharmaceutical product obtained by mixing at least one chemotherapeutic agent and at least one diluent; and a gripping and carrier device to transfer the containers between the therapeutic cartridge and the dosage station. The formulation instructions for mixing the therapeutic infusions are stored in a computer terminal 5 at the remote site, within the robotic infusion system 30 itself, and/or within the central computer 10. The formulations instructions can be updated continuously on a periodic basis via the internet or other means. As a result, optimal formulation instructions can be maintained at remote locations providing patients 80 with optimal treatment plans.

In certain embodiments, the robotic formulation mixer 30 has a decentralized architecture that has a small footprint to enable easy placement in remote facilities. Decentralized architecture is used herein to mean that control of the robotic mixer can be achieved from a separate location. In the context of this invention, separate location refers to a room, facility, or location that is distant from the location of the robotic infusion formulation mixer. For example, the separate location can be a central pharmacy of a major hospital system which is connected to healthcare facilities located distant from that central pharmacy.

In these embodiments, a remote computer terminal 5 is connected to a computer terminal 10 at a separate location. The robotic formulation mixer 30 receives formulation instructions a computer at the separate location to prepare a therapeutic infusion 90 for a patient 80. The remote computer 5 and/or the robotic mixer 30 may also be configured to monitor the inventory, amount of therapeutics in the robotic mixer, and the time the therapeutics have been in the robotic mixer 30. The remote computer 5 and/or the robotic mixer 30 may be configured to send any gathered information to a computer located at a separate location. Embodiments of the invention include a decentralized architecture, such as that given in by U.S. Patent Publication 2008/0195416, for example.

The robotic mixer 30 may contain additional components, such as therapeutic mixing apparatus, apparatus to measure the amount of therapeutics left in the containers, and/or RFID or bar code readers. The robotic mixer 30 may also include a refrigeration apparatus to regulate the temperature within the robotic mixer 30, and/or a sterilization apparatus, such as a UV sterilizer. Other mixer components that could be added, such as those found in U.S. Patent Publication 2010/0006602, for example.

Transportable Therapeutic Cartridge

The transportable therapeutic cartridge comprises at least a transport shell and a receptacle structure. The transport shell provides a closed-system environment for therapeutic agent containers. The transport shell may be constructed of transparent plastic, such as acrylic, to facilitate visual inspection and/or maintenance with the enclosure. The transport shell may be sealable to prevent influences of external factors on the transport shell, and may contain a small volume of controlled (with respect to motion, gas flow direction and external contaminants), particle-free gas to provide a clean environment for the receptacle structure and its contents.

The transport shell may have mechanical interface to provide a seal between the robot mixer and the transport shell. This purpose may be accomplished, in part, by mechanically ensuring that during transportation and storage the gaseous media (such as air or nitrogen) surrounding the receptacle structure is essentially stationary relative to the receptacle structure and by ensuring that particles or microbes from the ambient environment do not enter the immediate receptacle structure environment.

In addition to providing a stable environment during transportation, the mechanical interface provides a transfer mechanism to load/unload receptacle structures from a sealed transport shell without contamination of the therapeutic vials in the receptacle structure from external environments. In a preferred embodiment, the mechanical interface is based on a standardized mechanical interface (SMIF) system used in the manufacture and processing of silicon wafers in the electronics industry as proposed by the Hewlett-Packard Company is disclosed in U.S. Pat. Nos. 4,532,970 and 4,534,389.

The receptacle structure is defined by one compartment or a plurality of compartments for holding therapeutic agent containers that is designed to be directly inserted into the robotic mixer as well as protect the contents from forces or impact shocks associate with transport, thus preventing breakage of the therapeutic containers. In one embodiment, the receptacle structure can be made out of polyvinylchloride (PVC), polyurethane, thermoplastic rubber or other suitable material that can be injection molded and tolerate an impact without breaking.

The therapeutic cartridge's receptacle structure can be preloaded external to the robotic infusions formulation mixer with different therapeutic agent containers, decontaminated, and enclosed in the transport shell for transportation and placement into the robot infusion mixer. The therapeutic cartridge provides a closed system for the transport of the therapeutic agent containers throughout the process and provides an improved stable environment for the therapeutic agents and the robotic infusion mixer. That is to say, the transportable cartridge mechanically prohibits the transfer of environmental contaminants into the cartridge and the escape of hazardous drug outside the cartridge.

Therapeutic vials are stored in the receptacle structure and transported in transport shell, and are transferred from the transport shell to the robotic mixer in the following manner. First, a transport shell is placed at the interface port of the robotic mixer. Each transport shell includes a port door designed to mate with doors on the interface ports of the robot mixer. After the transport shell is placed at the interface port of the robotic mixer, latches release the transport shell door and the robot mixer enclosure port door simultaneously; the transport shell door and the interface port door are opened simultaneously so that particles which may have been on the external door surfaces are isolated. In one embodiment, a mechanical elevator lowers the two doors, with the receptacle structure riding on top, into the robot mixer enclosure covered space. A manipulator picks up the therapeutic vials from the receptacle structure for use in making therapeutic infusions. After making the therapeutic infusion, the reverse operation takes place.

As illustrated in FIG. 1, the robotic infusion mixer 30 of this invention stores the therapeutic agents 85 used to compose therapeutic infusions 90 in preloaded therapeutic cartridges 50. In one embodiment, the transportable therapeutic cartridges 50 can be preloaded at an off-site location and shipped to the facility having the robotic infusion mixer 30 prior to being placed into the robotic infusion mixer 30. In this situation, the therapeutic cartridge provides protection and a stable environment to the therapeutic agents during the transportation. In another embodiment, the therapeutic cartridges 50 can be preloaded immediately prior to placing into the robotic infusion mixer to make a therapeutic infusion.

The transportable therapeutic cartridges 50 can be preloaded at a separate time and shipped to the location and placed into the robotic infusion mixer on a scheduled basis. These preloaded therapeutic cartridges 50 can be used to quickly and efficiently replenish the robotic formulation mixer 30 on a periodic basis. The use of the preloaded therapeutic cartridge 50 permits multiple treatments before the robotic infusion mixer 30 needs to be replenished. This provides increased safety as well as labor and material cost savings. Each preloaded cartridge 50 can contain multiple commercial vials of different therapeutic agents 85. This permits the robotic infusion mixer 30 to make different therapeutic infusions without reloading.

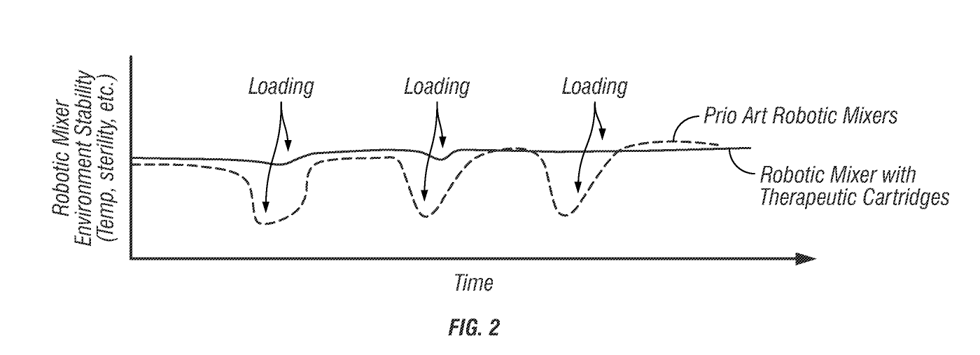

In addition to the improved safety and efficiency, the use of preloaded transportable therapeutic cartridges 50 permits a stable internal environment for the therapeutic containers during transportation and after placement in the robotic infusion mixer. As illustrated in FIG. 2, the internal environment (sterility, particulate count, temperature, etc.) for the prior art robotic formulations mixers can vary because the robotic mixer needs to be opened to the environment with the loading and unloading of the therapeutic agents. This is similar to what occurs with the internal environment of a refrigerator with the opening and closing of a refrigerator door. The use of a therapeutic cartridge allows the therapeutic cartridge to be protected during transportation and insertion into the robotic mixer and mechanically prohibits the transfer of environmental contaminants into the cartridge and the escape of hazardous drug outside the cartridge. Furthermore, the use of therapeutic cartridges minimizes the loading and unloading since each therapeutic cartridge can contain multiple commercial vials of the therapeutic agents.

As way of an example, the preloaded transportable therapeutic cartridges 50 can be packaged with different therapeutic agents containers at a location such as in a pharmacy facility located on site or off site from the robotic mixer 30. Additionally, the preloaded therapeutic cartridges 50 can be prepared ahead of time and shipped from a central pharmacy, specialty pharmaceutical company, pharmaceutical benefits management company, etc.

Benefits of preloading different therapeutic agents 85 into the therapeutic cartridge 50 are that it permits increased quality control measures and greater efficiency. These increase quality control measures include the use of RFID tags and readers, bar code and bar code readers, controlled environment, limited access, and other such methods. The therapeutic cartridges can be designed so as to be sterilized using UV light and shipped to remote locations. Each cartridge can contain multiple commercial vials of the different therapeutic.

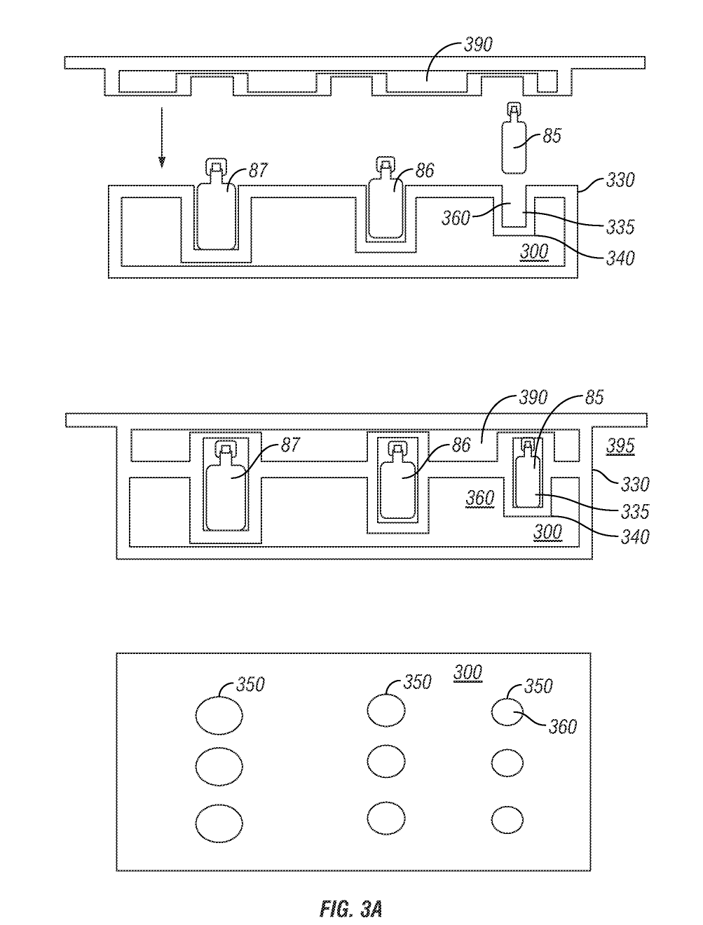

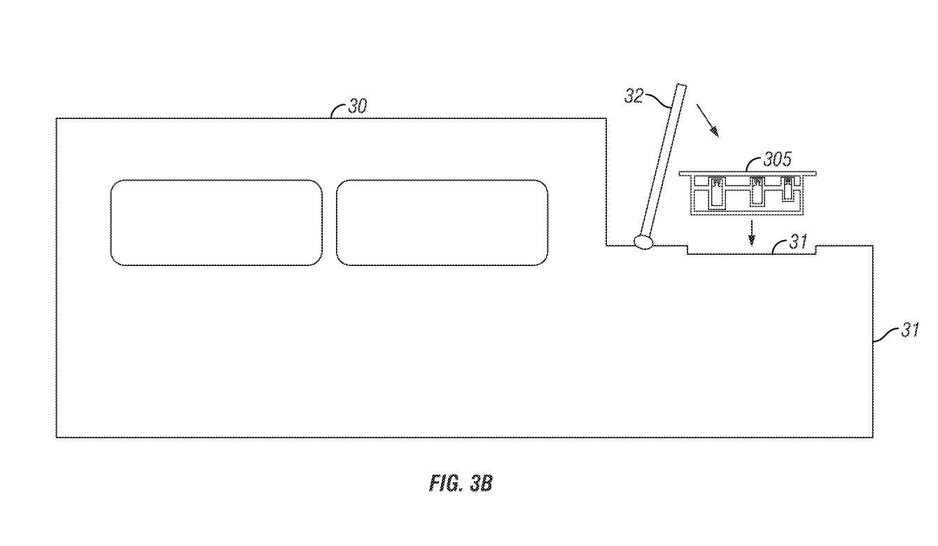

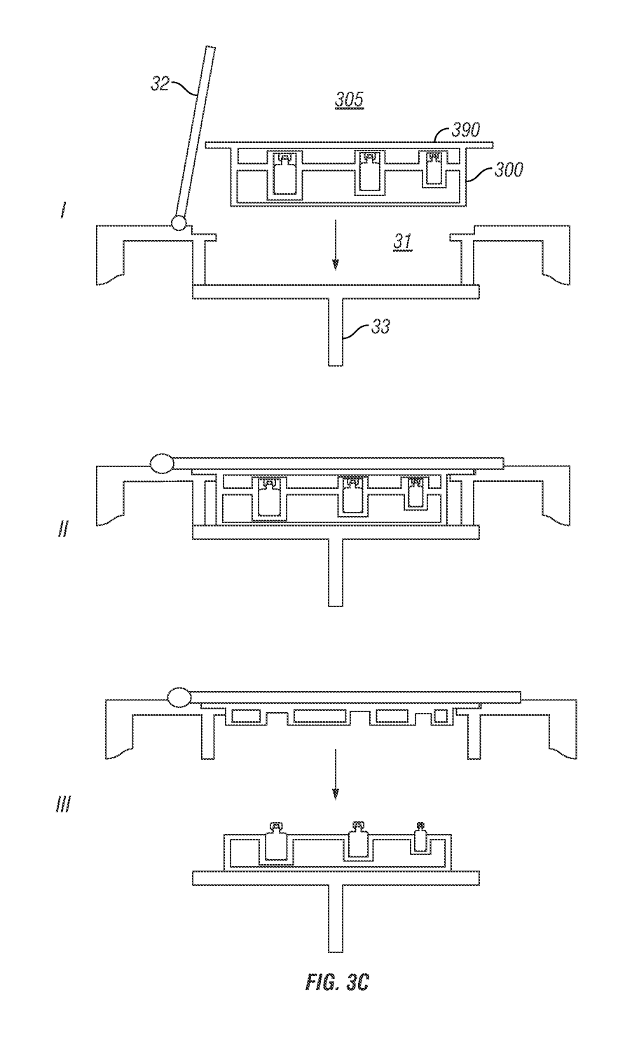

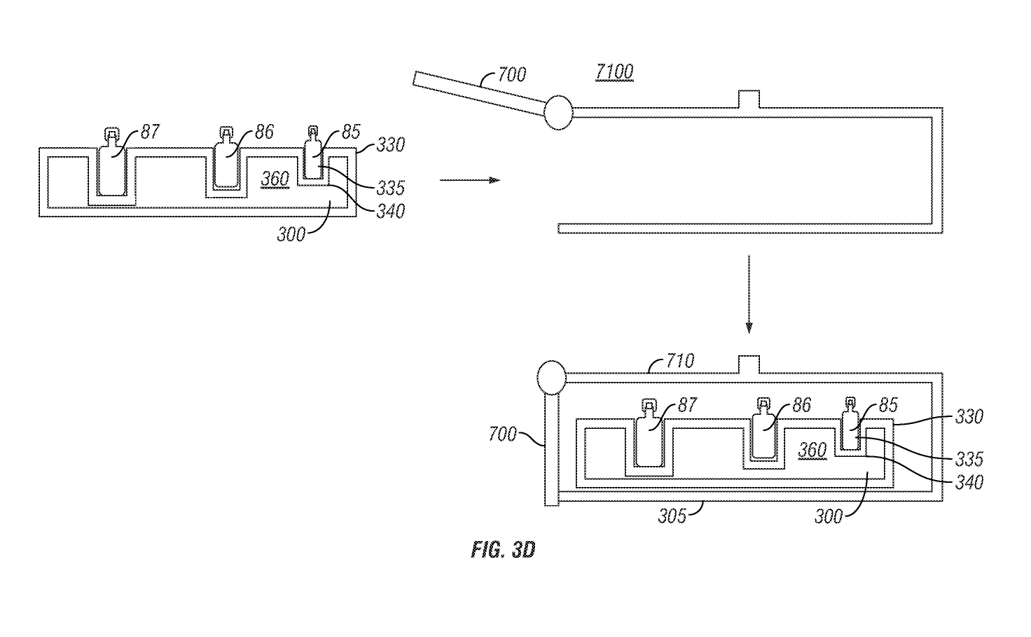

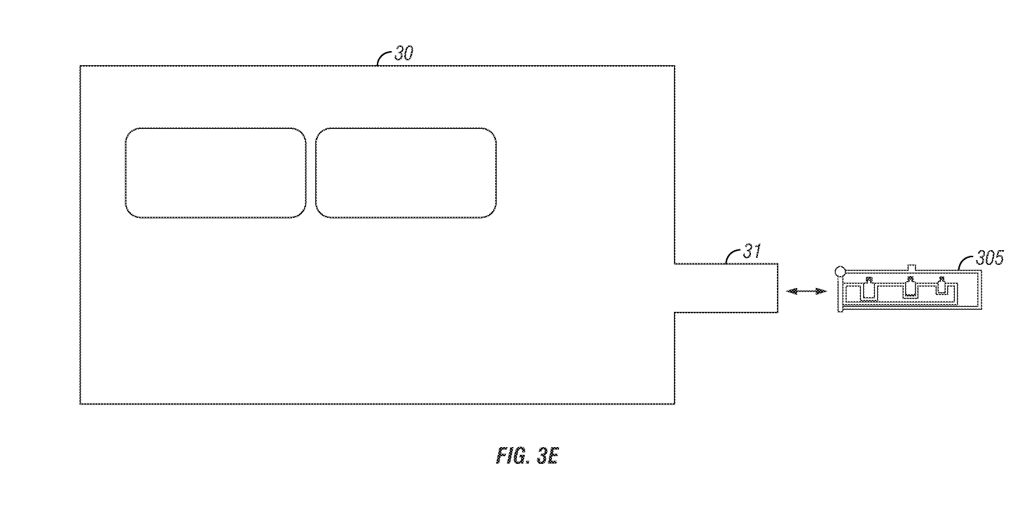

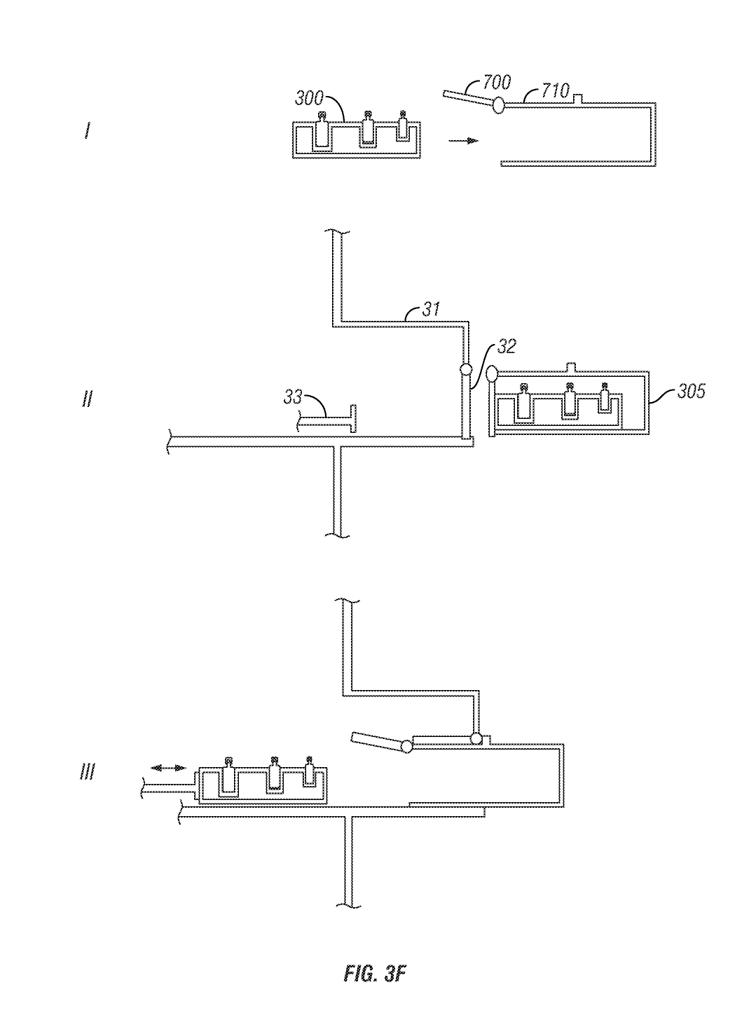

FIG. 3a is an illustration of an embodiment of transportable therapeutic cartridge 305 comprising a transport shell 390 and a receptacle structure 300. The transport shell provides a closed-system environment for therapeutic agent containers being held in the receptacle structure within the transport shell. As illustrated, a mechanical interface can act as a ‘cap’ to the receptacle structure 300, thereby coupling the transport shell to the receptacle structure in a cap configuration. FIG. 3b is an illustration of the placement of the therapeutic cartridge 305 into the robotic formulation mixer 30. As shown, the therapeutic cartridge 305 is loaded into a cartridge portal 31 on the robotic formulation mixer 30 using the mechanical interface between transportable therapeutic cartridge and the robot mixer. To ensure protection from the external environment, a portal door 32 is closed after placement of the therapeutic cartridge to the robotic formulation mixer.

FIG. 3c provides an illustration of one approach to the transfer of the therapeutic containers from the therapeutic cartridge 305 into the robotic formulation mixer 30. As shown in FIG. 3C (I), the therapeutic cartridge 305 is placed into the cartridge portal 31 of the robot mixer. In this embodiment, the external shell 390 of the therapeutic cartridge has a mechanical interface with the cartridge portal 31 of the robot mixer (“cartridge portal”) so as to provide a seal. As illustrated in FIG. 3C (II), after placement into the cartridge portal 31, the portal door 32 is closed isolating the internal environment of the therapeutic cartridge from the external environment. Finally, as illustrated in FIG. 3C (III), the cartridge receptacle 300 containing therapeutic agent containers is lowered into the robot infusion mixer utilizing a receptacle structure transport 33. After therapeutic vials have been used by the robot mixer to make therapeutic infusions, the therapeutic vials may be returned to the receptacle structure. After all the therapeutic vials have been used, or a new receptacle structure is desired, the process is reversed.

FIG. 3d is an illustration of another embodiment of transportable therapeutic cartridge 305 consisting of at least a transport shell 710 and a receptacle structure 300. The transport shell provides a closed-system environment for therapeutic agent containers and in one embodiment is a removable closure that encloses the receptacle structure 300. FIG. 3e is an illustration of the placement of the therapeutic cartridge 305 into the robotic formulation mixer 30. As shown, the therapeutic cartridge 305 is loaded into a cartridge portal 31 on the robotic formulation mixer 30. In this embodiment, the therapeutic cartridge 305 is pushed into the therapeutic portal 31. To ensure protection from the external environment, the therapeutic portal 31 provides a seal to the therapeutic cartridge 305 after placement of the therapeutic cartridge into the robotic formulation mixer.

FIG. 3f provides an illustration of another approach to the transfer of the therapeutic containers from the therapeutic cartridge 305 into the robotic formulation mixer 30. As shown in FIG. 3f (II), the therapeutic cartridge 305 is placed into the cartridge portal 31. In this embodiment, after insertion into the cartridge portal 31, the external shell door 700 of the external shell 390 opens exposing the therapeutic cartridge receptacle. As illustrated in FIG. 3f(II), after placement of the therapeutic cartridge 305 into the cartridge portal 31, the therapeutic agent containers are isolated from the external environment. Finally, as illustrated in FIG. 3C (III), the cartridge receptacle 300 containing therapeutic agent containers is drawn into the robot infusion mixer utilizing a receptacle transport 33.

Embodiments of the robotic formulation mixer can use additional sterilization procedures when loading or unloading cartridges to be sure to maintain a sterile environment within the mixing system. Specifically, the mechanical interface between the robot mixer and the transportable therapeutic cartridge can be decontaminated using such procedures as UV sterilization, aqueous alkaline detergent or bacterial solution wash and 70% alcohol solution rinse.

The transportable therapeutic cartridge may also include a temperature regulator, such as a gel pack, a refrigeration device, or water. The transportable therapeutic cartridge may also include thermal insulation, removable multiple insulated liners formed from a plurality of rigid foam panels, and a removable spill containment device, such as a liner, which prevents leakage of liquids and provides additional protective padding.

Receptacle Structure

The receptacle structure is defined by one compartment or a plurality of compartments for holding therapeutic agent containers that is designed to be directly inserted into the robotic mixer as well as protect the contents from forces or impact shocks associate with transport, thus preventing breakage of the therapeutic containers. The therapeutic cartridge's receptacle structure can be preloaded external to the robotic infusions formulation mixer with different therapeutic agent containers and enclosed in the transport shell for transportation and placement into the robot infusion mixer. In one embodiment, the receptacle structure can be made out of polyvinylchloride (PVC), polyurethane, thermoplastic rubber or other suitable material that can be injection molded and tolerate an impact without breaking.

As illustrated in FIG. 3a, the receptacle structure 300 is defined by one compartment or a plurality of compartments wherein the receptacle structure has the same or various size compartments 350 to hold different size therapeutic agent containers 85, 86, 87. In one form, the receptacle structure provides a structure defining one compartment or a plurality of compartments wherein the compartments have an upper flange 330, a lower base 340, and a wall 335. The wall 335 interconnects upper flange 330 and the lower base 340 of the compartment. The wall defines at least one cuplike recess 360 for receiving a therapeutic agent container 85, such as a vial. Each cuplike recess has a maximum diameter and is sized to hold a specific container size. As shown in FIG. 3a, the compartments can be of a variety of sizes to fit specific container sizes 85, 86, 87. Furthermore, the compartments can be of any geometrical shapes, and can be the same shape as the containers that will be utilized by the robotic mixer system. The receptacle structure is designed to fit within or attached to transport shell 390 or 710, for example, of the therapeutic cartridge 305 that protects the therapeutic containers being held by the receptacle structure during transportation and mechanically prohibits the transfer of environmental contaminants into the cartridge and the escape of hazardous drug outside the cartridge.

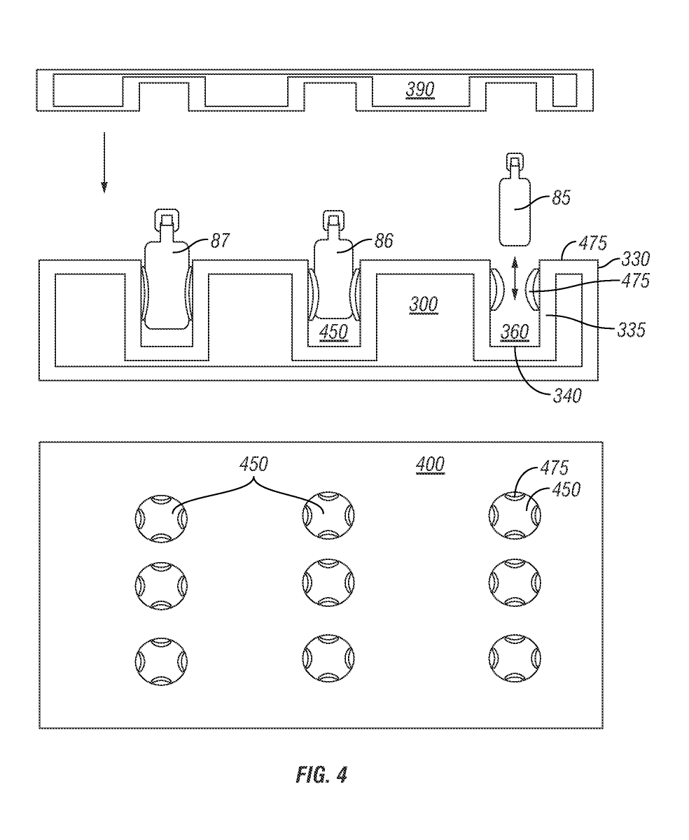

FIG. 4 is an illustration of another embodiment of receptacle structure 300 wherein the receptacle structure has compartments 450 that contain pliable structures 475 to hold therapeutic agent containers of different sizes 85, 86, 87. The receptacle structure 300 may comprise a structure defining one compartment 450 or a plurality of compartments 450 for holding therapeutic agent containers 85. Each compartment 450 is of a uniform size. To accommodate therapeutic agent containers of different sizes 85, 86, 87, each compartment 450 has at least one resiliently deflectable portion 475 to aid in holding said therapeutic agent containers.

In one form, the receptacle structure 300 provides a structure defining one compartment or a plurality of compartments wherein the compartments have an upper flange 330, a lower base 340, and a wall 335. The wall 335 interconnects upper flange 330 and the lower base 340 of the compartment. The wall defines at least one cuplike recess 360 for receiving the therapeutic agent container 85. Each cuplike recess 360 has a maximum diameter. The wall 335 is formed to include at least one resiliently deflectable portion 475 associate with each recess 360. The resiliently deflectable portion 475 extends inwardly from the maximum diameter. In one form, the resiliently deflectable portions 475 are four in number and are equally spaced about the maximum diameter. The receptacle structure is designed to fit within or attached to transport shell 390 or 710, for example, of the therapeutic cartridge 305 that protects the therapeutic containers being held by the receptacle structure during transportation and mechanically prohibits the transfer of environmental contaminants into the cartridge and the escape of hazardous drug outside the cartridge.

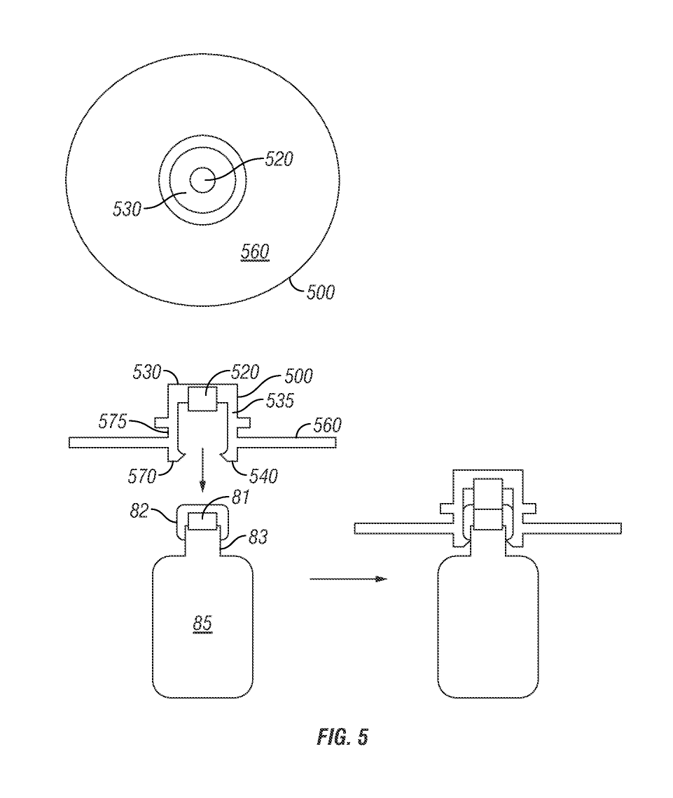

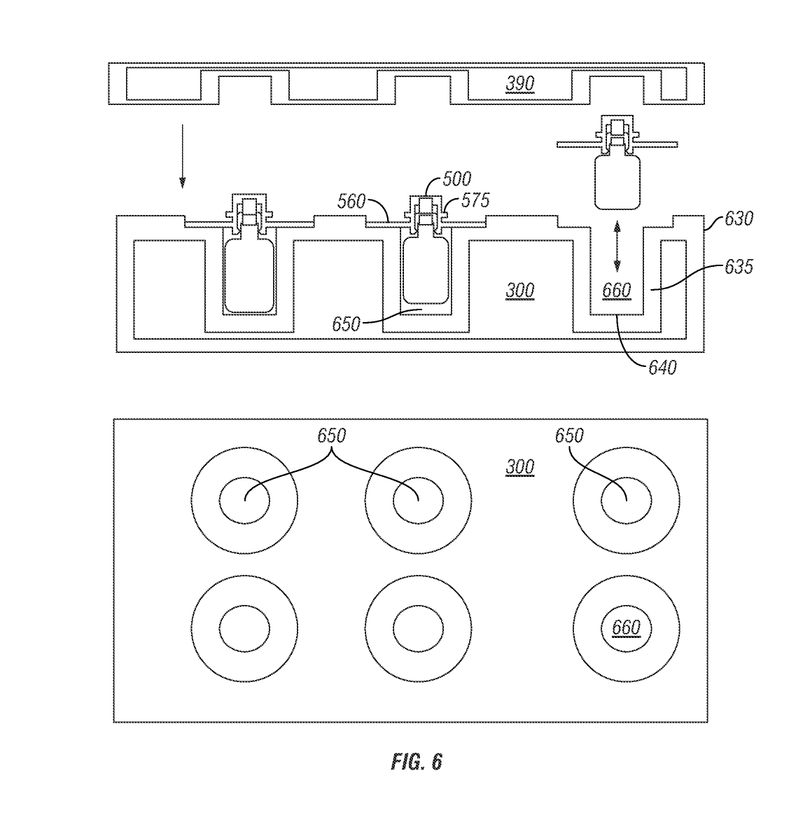

FIG. 5 illustrates one embodiment of the robotic transfer device 500 wherein the device comprises a first end 540, a body portion 535, and a second end 530. The first end 540 includes a connecting portion 570 for interconnectedness with the cap 82 of the therapeutic agent container 85. The connecting portion 570 consists of will a latching element that can be secured on the container cap's 83 rim. The second end 530 is opposite said first end 540 in its simplest form and provides an injection port 520 for use with a syringe. This injection port 520 abuts the therapeutic agent container cap's injection port 81. In more complicated forms, the second end 530 can be configured so as to secure infusion portal products currently on the market such as the CLAVE Universal Vial Spike (ICU Medical) and Infusion Luer Lock (Carmel Pharma).

The body portion 535 of the robot transfer device 500 connects the first end 530 with the second end 540 and comprises a flange 560 and a robotic hand universal gripping site 575. The robot transfer device's flange 560 provides a means to hold the therapeutic container 85 in the receptacle structure 300 regardless of the shape or size of the therapeutic container 85. The robotic hand universal gripping site 575 provides a means for transporting the therapeutic container using a robot gripping hand. A key benefit of utilizing robotic hand gripping site 575 is that the design and operation of the robot's gripping hand can be simplified since the robot gripping site 575 can be standardized. Thus the need for the robot ability to adjust to different therapeutic container's 85 shape or size is minimized.

FIG. 6 is an illustration of yet another embodiment of receptacle structure 300 wherein the receptacle structure comprises a structure defining one compartment or a plurality of compartments for holding therapeutic agent containers wherein the therapeutic agent containers 85 utilize robotic transfer device 500 attached to the cap portion of the therapeutic agent container 85.

As illustrated in FIG. 6, the receptacle structure 300 for this embodiment that utilizes the robotic hand universal gripping site 575 comprises a structure defining one compartment 650 or a plurality of compartments 650 for holding therapeutic agent containers 85. Each compartment 650 is of a uniform size. In one form, the receptacle structure 300 provides a structure defining one compartment or a plurality of compartments wherein the compartments have an upper flange 630, a lower base 640, and a wall 635. The wall 635 interconnects the upper flange 630 and the lower base 640 of the compartment. The wall defines at least one cuplike recess 660 for receiving the therapeutic agent container 85. Each cuplike recess has a maximum diameter and can be sized to hold therapeutic containers 85 of different sizes. The upper flange 630 of the receptacle structure 300 is designed to securely register with the therapeutic container's 85 flange 560 on the robotic gripping device 500, such as through an additional recess. The receptacle structure is designed to fit within transport shell 390 or 710, for example, of the therapeutic cartridge 305 that protects the therapeutic containers being held by the receptacle structure during transportation and mechanically prohibits the transfer of environmental contaminants into the cartridge and the escape of hazardous drug outside the cartridge.

FIG. 6 is an illustration of yet another embodiment of receptacle structure 300 wherein the receptacle structure comprises a structure defining one compartment or a plurality of compartments for holding therapeutic agent containers wherein the therapeutic agent containers 85 utilize robotic transfer device 500 attached to the cap portion of the therapeutic agent container 85.

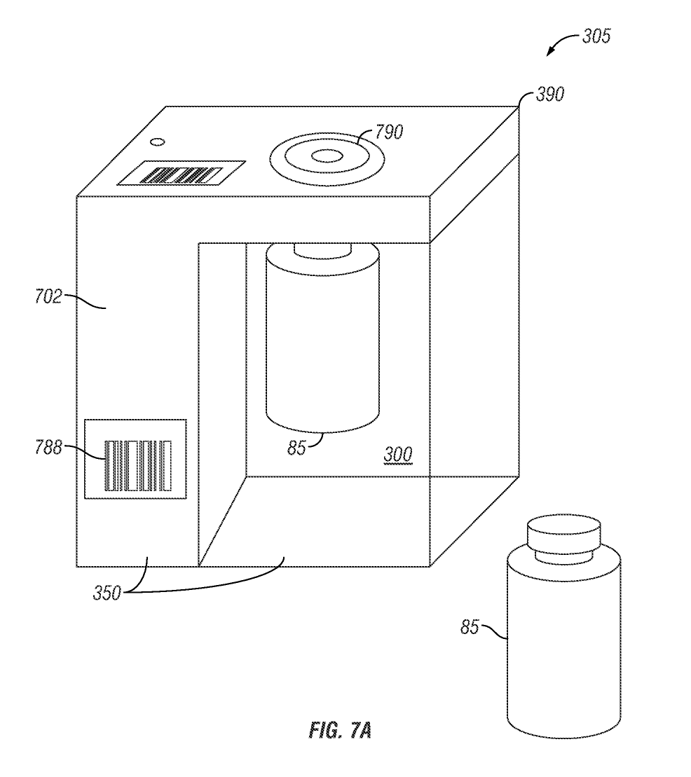

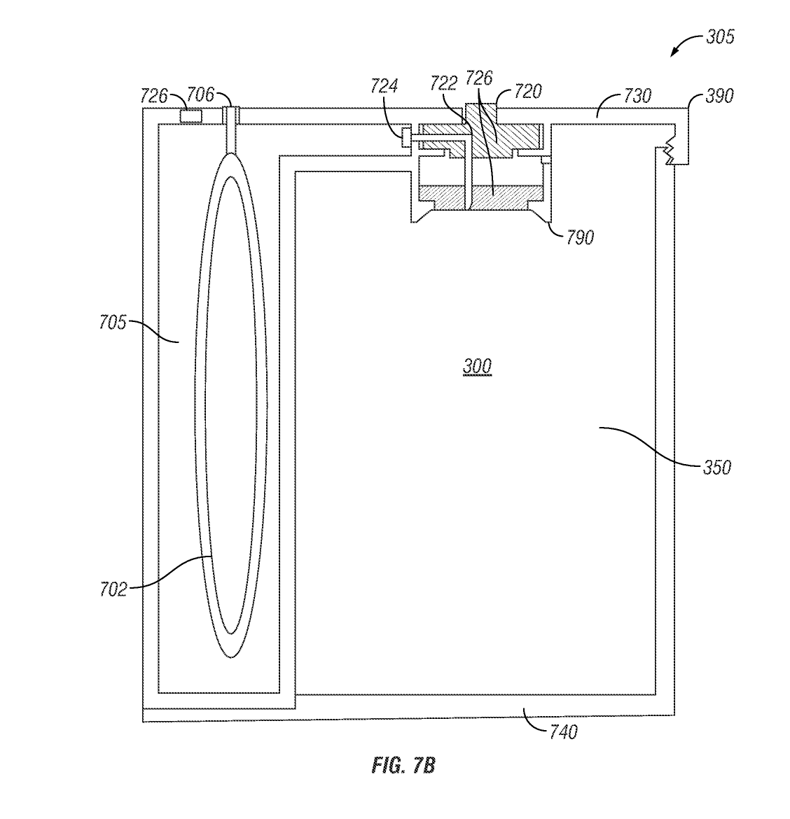

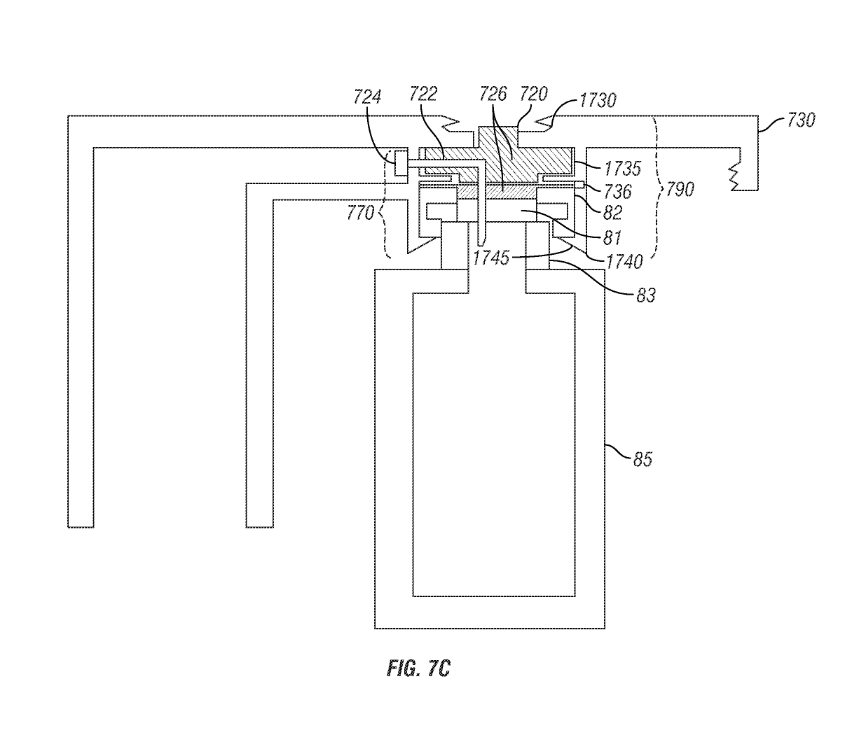

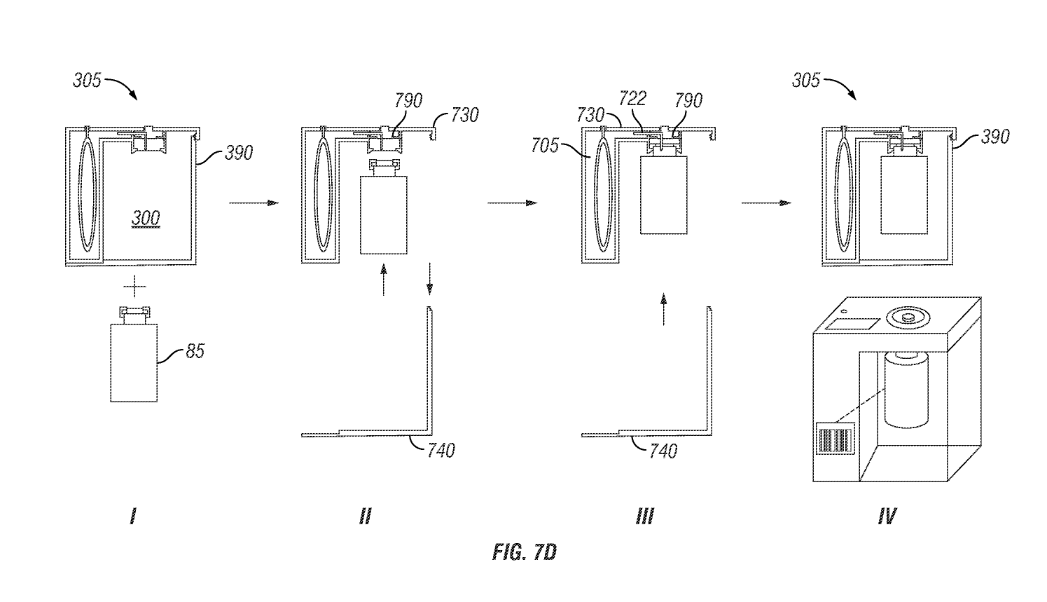

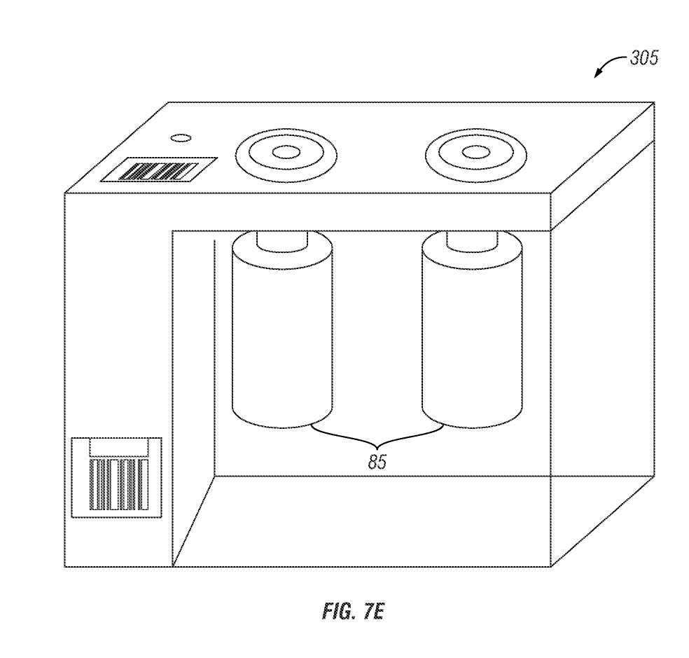

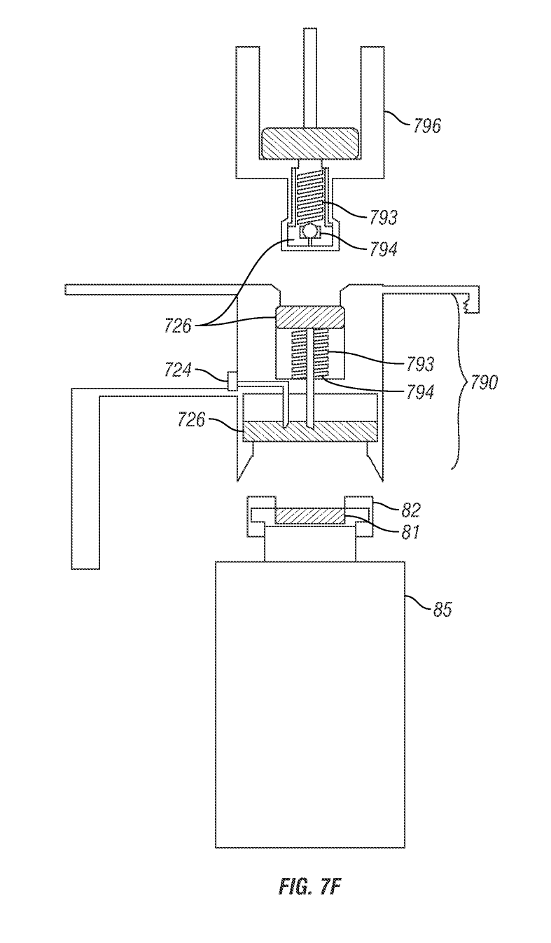

FIG. 7a is an illustration of yet another embodiment of the transportable therapeutic cartridge 305 comprising a transport shell 390 and a receptacle structure 300 wherein the receptacle structure 300 has a connecting structure 790 which is able to hold one or more therapeutic drug containers 85 which is integral with the transport shell. FIG. 7a provides an illustration of a transportable therapeutic cartridge which is holding one therapeutic drug container. FIG. 7e provides an illustration of a transportable therapeutic cartridge 305 which is holding two therapeutic drug containers 85.

In FIG. 7a the transport shell is defined by one compartment or a plurality of various size compartments 350 to hold different size therapeutic agent containers. In one form, the receptacle structure provides a connecting structure 790 which is integral to the transport shell 390 and able to hold a therapeutic drug container in the compartment 350 of the receptacle structure 300. In one form, one compartment or a plurality of compartments mechanically prohibits the transfer of environmental contaminants into the cartridge and escape of hazardous drug outside the cartridge. In one form, one compartment or a plurality of compartments 702 provides pressure modulation for the therapeutic drug container relative to the external environment. As illustrated in FIG. 7a, the transport shell provides a closed-system environment for therapeutic agent container 85 being held in the receptacle structure 300. As further illustrated in FIG. 7a, the transport shell can have an identifier as part of the transportable therapeutic cartridge such as a barcode 788 or RFID tag.

FIG. 7b provides a schematic drawing of the transportable therapeutic cartridge 305 embodiment illustrated in FIG. 7a. The receptacle structure 300 has a connecting structure 790 integral with the transport shell which is able to hold one or more therapeutic drug containers 85. The receptacle structure 300 is designed to hold a therapeutic drug container and provide an injection port for use with of a syringe. In one form, the receptacle structure 300 provides a structure defining one compartment or a plurality of compartments wherein the compartments are defined by an upper transport shell structure 730, a lower transport shell structure 740. The upper transport shell structure 730 and the lower transport shell structure 740 when combined provide a sealed environment for the receptacle structure 300. In one form, the transport shell can be open by separating the upper transport shell structure 730 from the lower transport shell structure 740 so as to permit the access to the connecting structure 790. In one form, the receptacle structure 300 also includes a flow channel 722 to enable pressure modulation between the inside of the therapeutic drug container 85 and the transport shell compartment 705. As shown in FIG. 7b, the flow channel can further incorporate a filter 724. To provide a means to modulate the internal pressure of the receptacle structure compartment, a sealable port 726 can be incorporated into the shell of the transport shell. As shown in FIG. 7b, the flow channel can further incorporate a filter 724. In one form, the transport shell compartment 705 contains a means to modulate the pressure with the external environment through the use of an elastic bulb 702 that provides pressure modulation with the external environment. As shown, the elastic bulb 702 communicates with the external environment through a port 706. As used herein, pressure modulations means that the one compartment or a plurality of compartments internal pressure can be made to be lower, higher or equal pressure to the external environment so the therapeutic drug container can have the desired pressure during the mixing of the therapeutic drug.

FIG. 7c provides a schematic drawing of the receptacle structure 300 embodiment illustrated in FIG. 7b wherein a therapeutic drug cartridge 85 is held by the connecting structure 790. In one form, the connecting structure 790 comprises a first end 1740, a body portion 1735, and a second end 1730. The first end 1740 includes a connecting portion 770 for interconnectedness with the cap 82 of the therapeutic agent container 85. The connecting portion 770 consists of a latching element 1745 that can be secured on the container cap's 83 rim. The connecting portion further consists of one or multiple elastomeric stoppers or membranes 726. The second end 1730 is opposite said first end 1740 in its simplest form and provides an elastomeric injection port 720 for use with a syringe. This injection port 720 abuts the therapeutic agent container cap's elastomeric injection port 81. In other embodiments, connecting structure 790 can be in the form of a needleless injection port as shown in FIG. 7f. In still other embodiments, a channel 736 can be provided in the body portion 1735 of the connecting structure 790 to permit a flow path for therapeutic drug drool when mixing or withdrawing the therapeutic agent from the therapeutic drug container. In more complicated forms, the second end 1730 can be configured so as to secure infusion portal products currently on the market such as the CLAVE Universal Vial Spike (ICU Medical) and Infusion Luer Lock (Carmel Pharma). In one form, the connecting structure 790 also includes a flow channel 722 to enable pressure modulation between the inside of the therapeutic drug container 85 and the transport shell compartments. As illustrated in FIG. 7b, the flow channel 722 communicates with the transport shell compartment 705. In one form, the receptacle structure compartment 705 contains a means to modulate the pressure with the external environment. In one embodiment, as illustrated in Fib 7b, an elastic bulb 702 that provides pressure modulation with the external environment. As shown, the elastic bulb 702 communicates with the external environment through a port 706. As the pressure within the receptacle structure compartment 705 decreases (e.g., when the therapeutic drug within the therapeutic drug container 85 is being withdrawn), the elastic bulb will expand to equalize the pressure. In another embodiment, a diaphragm or bellow can be used. In still another embodiment, the elastic bulb is directly connected to the flow channel.

FIG. 7d provides an illustration of one approach to the loading the transport cartridge 305 as illustrated in FIG. 7a. In step I, the transport cartridge 305 is empty. In step II, the transport cartridge 305 is opened. In one form the transport shell is opened into upper transport shell portion 730 and a lower transport shell portion 740. When opened, a therapeutic drug container 85 can be aligned with the connecting structure 790 in the receptacle structure 300. Step III illustrates the position of the therapeutic drug container 85 after it has been latched onto the connecting structure 790 in receptacle structure 300. At this point, the therapeutic drug container 85 is in communication with a chamber 705 through the flow channel 722 to provide an protective environment while providing pressure modulation between the inside of the therapeutic drug container 85 and the external environment. In step IV, upper transport shell portion 730 and a lower transport shell portion 740 are recombined to form a transportable therapeutic cartridge 305 containing one or more therapeutic drug containers 85.

The loaded transportable therapeutic cartridge 305 can be used to mix therapeutic drugs manually. Likewise, the therapeutic cartridge can be stored in a medication dispensing storage unit for later use. Furthermore, the transportable therapeutic cartridge 305 can be placed into the robotic formulation mixer 30 for automated therapeutic drugs.

Transferring Therapeutic Agent Containers by the Robot Infusion Mixer

As discussed above the robotic infusion mixer comprises a transportable therapeutic cartridge handling mechanism; a dosage station for the preparation of a pharmaceutical product obtained by mixing at least one therapeutic compound and at least one diluent; and a gripping and/or carrier device to transfer the containers between the therapeutic cartridge and the dosage station. In one embodiment, after the receptacle structure has been transferred into the robotic mixer, the robotic mixer may employ a robotic manipulator that has multiple degrees of freedom to transfer the therapeutic containers out of the receptacle structure. In this environment, the robotic manipulator is used to move the therapeutic agents, syringes, and IV bags are moved through the robot mixer system as the medications are processed.

In another embodiment, the therapeutic agent containers can be loaded and unloaded on the receptacle structure using a therapeutic container grabber that is positioned using a plurality of linear actuators. In this embodiment, the picker is positioned above the appropriate receptacle structure containing therapeutic agent containers, where it can be lowered to grip such container. Positioning of the picker can be accomplished using three linear actuators that move the picker to position to remove the therapeutic container from the therapeutic cartridge. After the therapeutic grabber has removed the therapeutic container from the receptacle structure, it can position and release the therapeutic container onto an accumulator belt which transports the therapeutic container to the dosage station.

As illustrated in FIG. 7, the robotic formulation mixer 30 can prepare a therapeutic infusion using the stored therapeutic agents in transportable therapeutic cartridges 50 which are preloaded with different therapeutic agents in their disposable containers 85. The preloaded therapeutic cartridges 50 provide a stable environment for the robotic formulation mixer to prepare said different therapeutic agents. These preloaded therapeutic cartridges 50 can be replaced on a periodic basis so as to replenish the robotic formulation mixer 30.

The process for providing preloaded therapeutic cartridges 50 is illustrated in FIG. 7. Briefly, the therapeutic cartridge 50 is prepared at a separate location. An empty therapeutic cartridge is filled with specific chemotherapeutic agent containers 85. As discussed above, the therapeutic cartridges can be preloaded with a single therapeutic agent or multiple therapeutic agents. After the empty therapeutic cartridge has been filled, the preloaded cartridge can undergo some post loading processing to ensure that the right therapeutic agents have been put into the cartridge. Furthermore, the therapeutic cartridge could potentially undergo sterilization procedures such as exposure to UV light. The preloaded cartridge or the containers inside the cartridge may be tagged with a bar code or an RFID tag, for example, in order to identify the identity, concentration and/or amount of therapeutics inside.

Upon request from a remote location having a robotic mixer, the preloaded transportable therapeutic cartridge can be shipped to that remote location. At the remote location, the preloaded cartridge can be inserted into the robotic infusion mixer. At the remote facility, the robotic infusion mixer prepares the therapeutic infusion for administration to the patient utilizing instructions stored in the computer terminal at that remote location, in the robotic mixer, or at a computer at a separate location. After the therapeutic agents have been used, the spent therapeutic cartridge can be transported for reprocessing or disposal.

The transportable therapeutic cartridge 50 provides a stable environment throughout the process that minimizes cross-contamination and waste. Furthermore, after the therapeutic containers have been loaded into the therapeutic cartridge the therapeutic agents within cartridge never need be touched by individuals at the remote facility, maximizing employee safety and minimizing contamination and mistakes. Additionally, after the therapeutic agents have been used, the spent therapeutic cartridge can be transported directly to the separate location for reprocessing or disposal. Again, this minimizes operator exposure to toxic agents.

Benefits

The robotic infusion mixer system of this invention can improve patient and provider safety while reducing waste. This robotic infusion mixer system eliminates the significant problems of the prior art associated with the need to manually fill the robotic system with individual containers of therapeutic agents including safety, waste, throughput and reliability.

Specifically, the robotic system of this invention utilizes a transportable therapeutic cartridge preloaded with therapeutic agent containers. The preloaded therapeutic cartridge improves operator safety by minimizing exposure to toxic therapeutic agents. Additionally, the use of the robotic system of this invention minimizes administrative costs and maximizes healthcare efficiency by decreasing drug waste, improving inventory control and improving personnel utilization. An inventory system and container monitoring system may be included with robotic system, and in this way the location and amounts of therapeutics may be audited. The system may also keep track of the amount of time a container has been inside the robotic system and/or the amount of time from the first use of the therapeutic. The information collected by the inventory and container monitoring system may be sent to a computer at a separate location.

The use of transportable therapeutic cartridges of this invention provides an improved stable environment to the therapeutic agents during transportation to the robotic system. Additionally, and more importantly, given the improved stable environment, the therapeutic cartridge has the potential for a longer shelf-life after the container has been opened while in the robotic infusion mixer. As a result, the use of the therapeutic cartridge could enable more efficient utilization of the therapeutic agent.

In addition to providing a stable environment, the use of a transportable therapeutic cartridge that can hold one or more therapeutic agent containers has a number of major advantages. Having multiple containers of the therapeutic agent in the therapeutic cartridge enables the robotic formulation mixer to make multiple therapeutic infusions for different patients without having to be reloaded. Likewise, the therapeutic cartridge can hold a container containing the therapeutic drug and a container containing the diluent. This saves time and labor costs to the healthcare facility.

Finally, the transportable therapeutic cartridge can be transported from the other locations to the robotic infusion mixer system utilizing standard transportation services such as Fed Ex, UPS, courier services, etc. At the distant healthcare facility, the therapeutic cartridge can be stored until needed or are inserted into the robotic infusion formulation mixer. After the containers containing the therapeutic agents have been used to formulate therapeutic infusions, the spent therapeutic cartridge can be disposed or returned to the benefits management service location for replenishment or disposal. Containers may include therapeutic containers such as vials and the like.

Uses

In addition to providing a robotic system that has the benefits discussed above, the robotic infusion mixer system of this invention would permit hospital systems with multiple off-site clinics and facilities the ability to provide offsite infusion mixing services in a cost effective way by having single centralized service for providing preloaded transportable therapeutic cartridges. This unit could provide the health system an approach to maximize the safety to the patients at these remote locations by minimizing human error from the onsite formulation of the infusions. Furthermore, it would provide the healthcare system a way to protect technicians from exposure to potentially dangerous drugs.

Additionally, the robotic infusion mixer system would permit third parties such as pharmaceutical benefits management companies, specialty pharmaceutical companies and payers a way to provide centralized therapeutic infusion agent distribution. This would allow these companies a method to improve quality of patient care while minimizing costs. The potential costs savings from utilizing the robotic infusion mixer system include volume purchase discounts on the therapeutic agents, waste loss reductions, labor efficiency, inventory carrying cost reduction, dose optimization/effectiveness, etc. The robotic infusion mixer system utilizing therapeutic cartridges is estimate to have potential costs savings of greater than 15%.

Finally, the robotic infusion mixer system would permit the ability to provide tele-pharmaceutical services for the delivery, and quality control, of just-in-time infusion mixing to remote sites such as prisons, army bases, corporate clinics in third world settings, etc. The capability of receiving formulation instructions originating from a computer located at a separate location permits the treatment of patients in remote locations utilizing the optimal drug mixture of a therapeutic infusion for said patient.

Method

Another embodiment of the invention is a method for providing therapeutic infusion benefits management services to a distant healthcare facility consisting of acquiring and holding therapeutic agents and using said agents to remotely make therapeutic infusions at said distant healthcare facility for administration to a patient. This method provides therapeutic infusion benefits management services to a physician in a just-in-time approach that minimizes the financial risks associated with acquiring, holding, mixing and administrating therapeutic agents to the patients. Furthermore, this method minimizes the medical risks to both the patient and its staff from manually mixing the therapeutic infusions on site.

Infusion Benefits Management Service

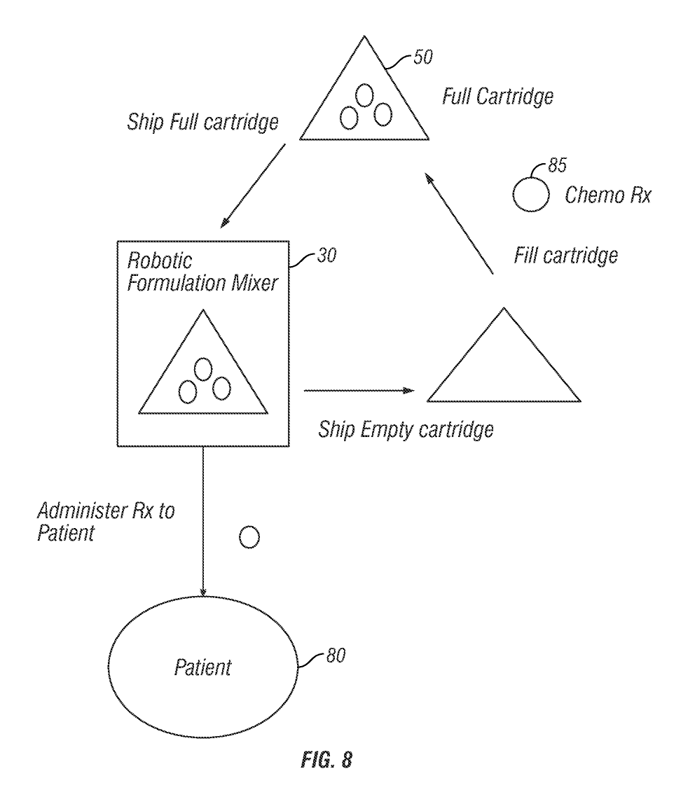

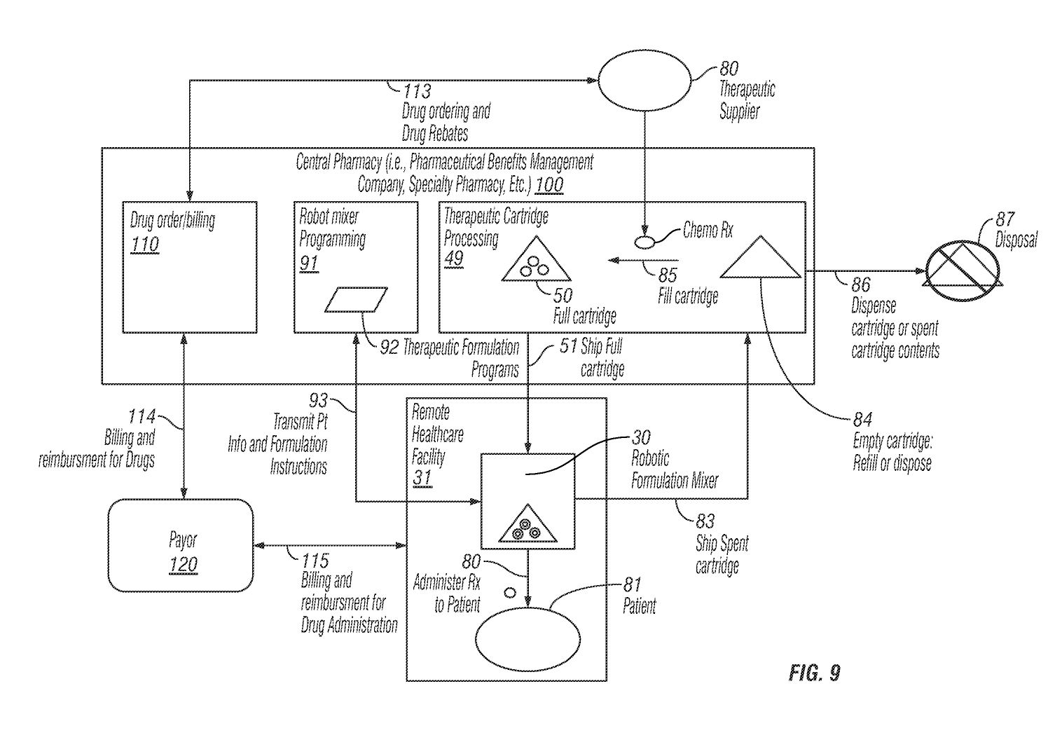

FIG. 8 illustrates one embodiment of the current invention of providing therapeutic infusion benefits services to a distant healthcare facility. The therapeutic infusion benefits management services may include a central pharmacy 100 that has a number of potential operations. One potential operation would be to provide for robot infusion mixer information support 91.

The robotic infusion formulation mixer information support 91 may include providing software and software update needed to operate the remote robotic mixer system. Additionally, the information support 91 would be able to supply the formulation programs needed for robot infusion formulation mixer system to formulate chemotherapeutic infusions at a distant location. The formulation programs are the instructions for how to formulate specific therapeutic infusion mixtures utilizing the remote robotic mixer system. These formation programs can be developed by the therapeutic infusion benefits management services company or by a third-party 90. The robotic infusion formulation mixer information support system may also monitor the inventory of therapeutics at remote robotic mixer locations, monitor the amount of individual containers at the remote robotic mixer location, and/or monitor the time since each of the therapeutics was first used or entered the system similar to what is currently being used for dispensing solid medication in pharmacies or remotely using robotic dispensing systems, such as those found in U.S. Patent Publication 2008/0195416, for example.

Another potential operation provided by the therapeutic infusion benefits management services company 100 is the therapeutic cartridge supply and processing 49. The therapeutic cartridge supply and processing operation entails taking empty cartridges 84 and loading with one or more vials or containing therapeutic agents 82 to obtain a preloaded therapeutic cartridge 50. The therapeutic agents 82 in the vials are supplied to the therapeutic infusion benefits management service company by the manufacturer or supplier of the therapeutic agent 83. Supply and processing may occur at a location separate from the information support system, such as at a warehouse or at a manufacturing facility.

At the therapeutic infusion benefits management service company, the empty cartridge 84 is designed to be filled with therapeutic vials 82 manually or using an automated process. The therapeutic cartridge is designed so that it can be filled with containers of multiple sizes. Furthermore the cartridge is designed so that the therapeutic vials and agents within these vials are protected from external environment while being transported to distant locations having robotic mixer system 30 and while in the robotic mixer. The cartridges may also be sterilized. The cartridges, or the contents in the cartridge may also be tagged, such as with a car code or an RFID tag to identify the contents, the concentration and/or the amount of therapeutics.

The preloaded therapeutic cartridge 50 is shipped 51 to the distant healthcare facility 31 having a robotic infusion formulation mixer system 30. At the remote healthcare facility 31, a healthcare provider inserts the preloaded therapeutic cartridge 50 into the robotic infusion formulation mixer 30. The use of the preloaded therapeutic cartridges would provide a stable environment for the robotic infusion mixer and the therapeutic agents during the preparation of said different therapeutic infusions 80 for use in different patients.

When a patient 81 comes to the distant healthcare facility 31 for a therapeutic treatment, the healthcare provider will enter into the robotic infusion formulation mixer 30 the desire treatment. The desired treatment could be entered at the central site or at the remote site. Up-to-date formulation instructions stored in the computer terminal originating from therapeutic infusion benefits service company are used to determine optimal drug mixture of a therapeutic infusion 80 for said patient 81. The robotic infusion formulation mixer makes the therapeutic infusion 80 utilizing therapeutic agents preloaded in the therapeutic cartridge 50. This therapeutic infusion 80 is administered to the patient 81.

After the robotic infusion formulation mixer 30 has used all the therapeutic agents 82 in the therapeutic cartridge, the spent therapeutic cartridge 83 can be disposed of or shipped back to the therapeutic infusion benefits service company 100. If the spent therapeutic cartridge is returned to the infusion benefits service company 100, the spent therapeutic cartridge 83 is either disposed of directly 86 in an appropriate disposal facility 87 or reprocessed to provide for an empty therapeutic cartridge 84. This empty therapeutic cartridge can be reused in a therapeutic cartridge processing 49.

Embodiments of the method of the invention provides therapeutic infusion benefits management services to a physician in a just-in-time approach that minimizes the physician financial risks associated with acquiring, holding, mixing and administrating therapeutic agents to the patients. The costs of drugs are the major expense in oncologist healthcare practice. Additionally, the time between purchasing the drug and reimbursement from a payer can be long resulting high capital costs. Furthermore, if a patient misses an appointment after a drug has been prepared, the physician can experienced a substantial loss. Finally, the use of the therapeutic infusion benefits management services can lead to improved utilization efficiency of the therapeutic agents which results in lower cost of therapeutic agent per infusion.

In addition to reducing the financial risks, embodiments of the method of this invention increases the safety to both the patient and the staff at healthcare facility site. For the patient, the use of a robotic mixer system reduces medication errors from the manual mixing of therapeutic infusions. For the staff, the use of the robotic infusion mixer system minimizes the exposure to toxic compounds as compared to the traditional preparation and administration of infusion drugs (i.e. due to airborne emission and surface pillage of the drug). Given the use of the robotic infusion mixer system, the due to airborne emission and surface pillage of the drug exposure to these toxic compounds due to airborne emission and surface pillage of the drug is minimized.

Finally, the use of the therapeutic infusion benefits management services can provide improved productivity in the healthcare provider's facilities. The use of the robotic fusion mixer system quickly and efficiently produces the therapeutic infusions on a just-in-time basis. Because of the use of a preloaded cartridge, the robotic infusion mixer system eliminates the significant problems associate with the need to manually fill the current robotic systems with individual vials of therapeutic agents.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

### REFERENCES

All patents and publications cited herein are hereby incorporated by reference in their entirety herein.
Akscin, John, Barr, Thomas and Towle, Elaine. Financial benchmarking: results from a survey of office-based oncology practices, part 2. Community Oncology. April 2007, Vol. 4, 4.
Akscin, John, Barr, Thomoas and Towle, Elaine. Benchmarking practice operations: Results from a survey of office-based oncology practices. Journal
Brixner, Diana, et al. Documentation of chemotherapy infusion presparation costs in academic and community based oncology practices. Journal of the National Comprehensive Cancer Network. 2006, Vol. 4, 3.
Chemotherapy Market Insights, 2006-2016: A critical analysis of cancer research, treatments, pipelines, and commercial opportunities. s.l.: Spectra Intelligence, April 2006.
Giribona, Paolo, et al. Machine for the Preparation of Pharmaceutical Products. 2010/0006602 USA, Jan. 14, 2010. Provisional.
Nygrem, Olle, et al. Exposure to anticancer drugs during preparation and administration. Investigations of an open and a closed system. Journal of Environmental Monitoring. 2002, 5.
Medicare cuts threaten access to cancer care in the United States. American Society of Clinical Oncology.
Nygrem, Olle, et al. Exposure to anticancer drugs during preparation and administration. Investigations of an open and a closed system. Journal of Environmental Monitoring. 2002, 5.
Osborne, Joel A., Tribble, Dennis and Khan, Abdul Wahid. Automated means for storing, dispensind and orienting injectable drug vials for a robotic application. 7240699 USA, Jul. 7, 2007.
Rob, Ronald H, Eliul, Walter W and Mlodzinski, Lance R. Automated pharmacy admixture system (APAS). U.S. Pat. No. 7,610,115 US, Oct. 27, 2009.
Vandendbroucke, Johan and Robays, Hugo. Economic impact of the preparation scenario for cytotoxic drugs: an observational study. EJHP Practice. 2008, Vol. 14, 5.

1. A transportable therapeutic cartridge comprising:
a transport shell; and
a receptacle structure configured to receive one or more therapeutic agents, and to be coupled to the transport shell such that one or more therapeutic agents disposed in the receptacle structure are protected;
wherein the cartridge is configured to be used to manually mix therapeutic agents and configured to be coupled to a therapeutic agent robotic mixer such that the robotic mixer can access therapeutic agents disposed in the cartridge.

2. The cartridge of claim 1, wherein the receptacle structure comprises a plurality of compartments configured to receive therapeutic agent containers.

3. The cartridge of claim 2, wherein at least one of the plurality of compartments is a different size than at least one other of the plurality of compartments.

4. The cartridge of claim 2, wherein at least one of the plurality of compartments is a different shape than at least one other of the plurality of compartments.

5. The cartridge of claim 2, wherein the plurality of compartments comprises at least one resiliently deflectable structure adapted to hold therapeutic agent containers in place.

6. The cartridge of claim 2, further comprising therapeutic agent containers configured to be received in the compartments of the receptacle structure.

7. The cartridge of any 2, wherein at least one of the plurality of compartments comprises a recess adjacent the top of the compartment.

8. The cartridge of claim 7, further comprising at least one robotic transfer device configured to fit into the recess.

9. The cartridge of claim 6, wherein the therapeutic agent containers contain one or more chemotherapy drugs.

10. The cartridge of claim 1, wherein the cartridge is configured to resist damage to contents of the cartridge during transport.

11. The cartridge of claim 1, wherein the cartridge is a closed-system drug-transfer device.

12. The cartridge of claim 1, wherein the transport shell surrounds the receptacle structure.

13. The cartridge of claim 12, wherein the transport shell is configured to seal the receptacle within the transport shell.

14. The cartridge of claim 1, wherein the transport shell is configured to be coupled to the receptacle structure in a cap configuration.

15. The cartridge of claim 14, wherein the transport shell is configured to be coupled to the receptacle to provide a seal between the transport shell and the receptacle.

16. The cartridge of claim 13, wherein the seal is airtight.

17. The cartridge of claim 1, wherein an interior of the cartridge is sterile.

18. The cartridge of claim 1, further comprising a temperature regulator or pressure modulator.

19. The cartridge of claim 18, wherein the temperature regulator comprises at least one of a gel pack, a refrigeration device, or water.

20. The cartridge of claim 18, wherein the temperature regulator comprises thermal insulation.

21. The cartridge of claim 1, wherein the cartridge is a closed-system drug-transfer device having the means to modulate pressure between the therapeutic drug container and the external environment.

22. An apparatus comprising:
a therapeutic agent robotic mixer configured to be coupled to a transportable therapeutic cartridge comprising:
a transport shell; and
a receptacle structure configured to receive one or more therapeutic agents, and to be coupled to the transport shell such that one or more therapeutic agents disposed in the receptacle structure are protected;
wherein the robotic mixer is configured to be coupled to the cartridge such that the robotic mixer can access therapeutic agents disposed in the cartridge.

23. A therapeutic agent robotic mixer comprising:
a therapeutic cartridge handling mechanism;
a dosage station;
a carrier device configured to transfer a therapeutic agent container between the therapeutic cartridge handling mechanism and the dosage station;
wherein the therapeutic cartridge handling mechanism is configured to permit the dosage station to access a therapeutic agent container without affecting sterility of the therapeutic agent container.

24. The robotic mixer of claim 23, wherein the therapeutic cartridge handling mechanism comprises a UV sterilizer.

25. The robotic mixer of claim 23, wherein the therapeutic cartridge handling mechanism is configured to remove a transport shell from a therapeutic cartridge.

26. The robotic mixer of claim 23, further comprising a computer.

27. The robotic mixer of claim 23, further comprising a refrigeration device.

28. The robotic mixer of claim 23, further comprising an input configured to receive information about loaded therapeutic agents.

29. The robotic mixer of claim 28, wherein the input comprises a barcode reader or an RFID scanner.

30. A system for formulation of therapeutic infusions comprising:
a transportable therapeutic cartridge of claim 1;
a robotic mixer as of claim 23; and
a computer remote from and configured to communicate with the robotic mixer, wherein the computer comprises a database, a processor, and a memory to store processor-executable program code.

31. The system of claim 30, wherein the database is configured to store information about patients, therapeutic treatments, and therapeutic agents.

32. The system of claim 30, wherein the computer is configured to receive requests for therapeutic agents.

33. The system of claim 30, wherein the computer is configured to monitor therapeutic agents.

34. The system of claim 33, wherein the computer is configured to audit therapeutic agents at the location of the computer and at the robotic mixer.

35. The system of claim 34, wherein the computer is configured to receive information on a treatment protocol for a patient for delivery at the location of the robotic mixer.

36. The system of claim 35, wherein the computer is configured to:
determine one or more therapeutic agents needed at the robotic mixer to deliver the treatment protocol;
determine whether the robotic mixer has access to the needed therapeutic agents; and
sends a request for any therapeutic agents not accessible by the robotic mixer to be sent in a transportable therapeutic cartridge to the location of the robotic mixer.

37. The system of claim 36, wherein the robotic mixer is configured to receive from the computer information for mixing a therapeutic formulation.

38. The system of claim 37, wherein the robotic mixer is configured to mix the therapeutic formulation based on the received information.

39. The system of claim 38, wherein the robotic mixer is configured to send to the computer information about therapeutic agents to which the robotic mixer has access.

40. A method for providing therapeutic infusion services comprising:
sending a transportable therapeutic cartridge having a sealed, sterile interior in which one or more therapeutic agents are disposed;
wherein the cartridge is configured to be coupled to a robotic mixer before unsealing the interior such that the robotic mixer can access the one or more therapeutic agents.

41. A method for providing therapeutic infusion services comprising:
acquiring therapeutic agents;
loading one or more of the therapeutic agents into a transportable therapeutic cartridge;
sterilizing the therapeutic cartridge;
sealing the therapeutic cartridge.

42. The method of claim 41, further comprising transporting the sealed therapeutic agent to a healthcare location.

43. The method of claim 42, wherein the healthcare location is a hospital.

44. The method of claim 42, further comprising coupling the therapeutic cartridge to a robotic mixer without breaking the seal of the therapeutic cartridge.

45. The method of claim 41, wherein the transportable therapeutic cartridge is a closed system drug-transfer device.

46. The method of claim 45, wherein the robotic mixer is configured to break the seal of the therapeutic cartridge after the cartridge is coupled to the robotic mixer.

47. The method of claim 46, wherein the robotic mixer mixes at least one of the one or more therapeutic agents into a therapeutic formulation for administration to a patient.
